(19) United States
(12) Patent Application Publication
(10) Pub. No.: US 2004/0096775 A1
(43) Pub. Date: May 20, 2004

(54) Optical recording materials having high storage density

(76) Inventors: Urs Lehmann, Basel (CH); Jean-Luc Budry, Rossemaison (CH); Beat Schmidhalter, Bubendorf (CH); Heinz Sphani, Frenkendorf (CH); Peter Sutter, Muttenz (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/472,636

(22) PCT Filed: Mar. 12, 2002
(86) PCT No.: PCT/EP02/02707

(30) Foreign Application Priority Data
Mar. 21, 2001 (CH) 519/01

(51) Int. Cl. G03C 1/492; G03C 1/494; G03C 1/76

(52) U.S. Cl. 430/276.1

(57) ABSTRACT

This invention relates to an optical recording medium, comprising a substrate, a reflecting layer and a recording layer based on compounds of formula (I), (II), (III) or (IV). Attention is drawn to the description for the precise meanings of the substituents. Recording and playback are carried out especially at a wavelength of from 350 to 500 nm, for example using a blue laser. The recording and playback quality is excellent and allows high storage density. Likewise claimed are some novel compounds of formula (I), (II), (III) or (IV), as well as an optical recording medium comprising, in the following arrangement, a) a supporting material consisting of a reflecting metal or, preferably, of a polymer having a reflection metallic layer; b) an optical recording layer; c) a separating layer consisting of a metallic, crosslinked organometallic or dielectric inorganic substance; and c) a covering layer.

The invention relates to novel optical recording materials that have an excellent recording and playback quality, especially at a wavelength of from 350 to 500 nm. Recording and playback can very advantageously take place at the same wavelength, and the storage density achievable is appreciably higher than in the case of known materials. In addition, the materials according to the invention have very good storage properties before and after recording, even under especially harsh conditions, such as exposure to sunlight or fluorescent tube light, to heat and/or to high humidity. They can also be produced simply and with good reproducibility using customary coating methods, such as spin coating. Many of the compounds used in the materials according to the invention are furthermore free of heavy metals, thus substantially facilitating recycling of the metallic reflector layer of, for example, white gold, silver or aluminium.

JP-A-07/126543 discloses the use of unsubstituted or substituted indolizine dyes of formula

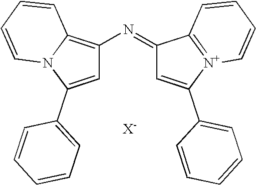

for optical recording materials, but such dyes are sensitive to oxidation and exhibit unsatisfactory light-fastness properties. Their optical properties are questionable. Writing in or near the UV range is possible, but not with the contrast necessary for high information density. In addition, reading must be in or near the IR range. Furthermore, the recording results do not fully satisfy high quality requirements, the maximum readable information density per unit area, in particular, being too low.

JP-A-11/34500 and JP-A-11/92479 disclose metal and boron complexes of dyes of formula

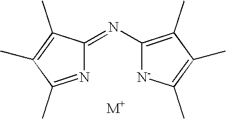

that can be used at from 520 to 690 nm for optical recording materials, such as CD-R or DVD-R. In that case, too, the optical properties are questionable and the maximum information density per unit area is much lower than desired.

Also, the properties in those systems, especially the spectral properties in or near the UV range necessary for maximum storage densities and the information density per unit area, are not able to satisfy the very high requirements as desired.

EP A-0 528 512 describes optical recording materials comprising two different cyanine dyes and two fluorescence quenchers in defined ratios. Recording and playback usually take place at from 770 to 830 nm. U.S. Pat. No. 5,061,796 discloses asymmetric azamethine dyes having high reflectivity at from 600 to 900 nm that are allegedly light- and heat-stable. U.S. Pat. No. 5,958,650 discloses the use of polymethine metal complexes for optical recording materials. The recording takes place preferably at from 600 to 800 nm, for example at 650 nm. In those three systems, too, however, the properties, especially the information density per unit area, are not able to satisfy the very high requirements as desired.

J. Imaging Sci. 47/2, 113-117 (1999), on the other hand, sees the future of optical recording materials in a DVD-R system that operates at 480 nm with a dye of formula

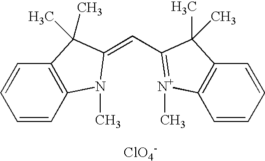

known from JP-A-04/74690 and JP-A-05/38879.

The molar extinction coefficient, however, is undesirably low.

JP-A-05/224347, on the other hand, discloses photo materials, exposable using a laser of a wavelength of from 300 to 500 nm, that comprise silver halide and a sensitizer, for example of formula

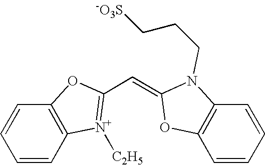

Analogous benzothiazole compounds are known from U.S. Pat. No. 3,850,645 as peptisating agents in photo materials based on silver halide, but such materials are not suitable for use in customary computer peripherals, such as CD-ROM, CD-R, CD-RW, DVD and DVD-R, since they need to be developed.

JP-A-03/284743 discloses optical recording materials comprising a photochromic spiropyran and a cyanine dye of formula

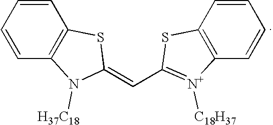

Those materials need to be quenched before being used, however, and are not suitable for use in customary computer peripherals such as CD-ROM, CD-R, CD-RW, DVD and DVD-R since they are sensitive to daylight. The optically recorded information is in addition not permanent and is already modified on playback. A fluorescence detector is necessary, making the construction of the reading apparatus more complicated and more expensive.

The same cyanine dye as in JP-A-03/284743 is also used by U.S. Pat. No. 5,316,899 in combination with a second, homologous cyanine dye to form bathochrome-shifted “J-aggregates”, but that system, too, is not suitable for the production of optical recording materials having high information density. The coating technique is furthermore difficult and the thickness of the layer is too low for apparatus of standard sensitivity.

Accordingly, prior optical recording materials meet only some of the high demands or do not meet all of the demands simultaneously to complete satisfaction.

The application WO-01/75873, which is not prior-published, discloses the use of a very large number of dyes in optical recording media that are writable using lasers in the wavelength range from 360 to 460 nm. Inter alia, formula

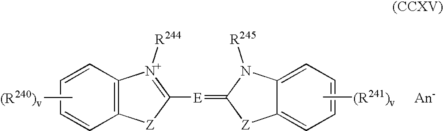

is disclosed, wherein E may be N, Z may be O, S or NR²⁴⁴, and R²⁴⁴ and R²⁴⁵ may each independently of the other be C₁- to C₁₆-alkyl. No definition of the anions An⁻ is given. In addition, the penultimate compound on page 57, embodiment examples, and precise details concerning the layers are missing from the priority application DE 100 16 699.

The aim of the invention is to provide an optical recording medium having high information density and high data reliability. That recording medium should be robust, durable and simple to use. In addition it should be cheap to produce on a large scale, require apparatuses that are as small and as inexpensive as possible, and contain as little as possible in the way of environmentally harmful substances, such as volatile or toxic metals, or at least allow easy disposal of such environmentally harmful substances.

The invention accordingly relates to an optical recording medium comprising a substrate, a recording layer and a reflecting layer, wherein the recording layer comprises a compound of formula

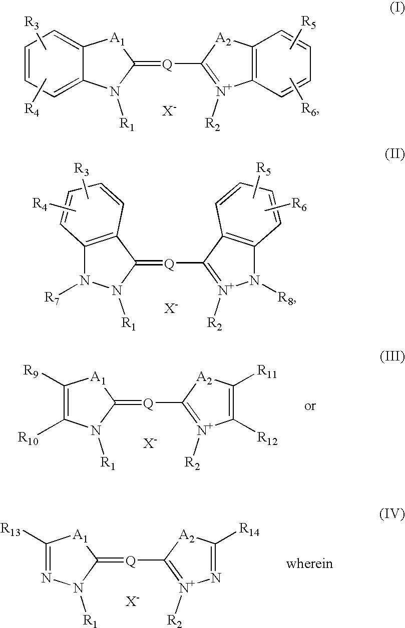

A₁ and A₂ are each independently of the other C(C₁-C₅alkyl)₂, C(C₄-C₅alkylene), N(R₁₅), O, S, Se, or unsubstituted or R₁₆-substituted CH═CH;

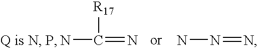

X⁻ is an inorganic, organic or preferably organometallic anion having a negative charge or is 1/x of an inorganic, organic or organometallic anion having x negative charges, x being a number from 2 to 4, or is a mixture thereof;

R₁, R₂, R₇, R₈ and R₁₅ are each independently of the others C₁-C₂₄alkyl, C₃-C₂₄cycloalkyl, C₁-C₄alkyl-[O—C₁-C₄alkylene]ₘ, C₁-C₄alkyl-[NH—C₁-C₄alkylene]ₘ, C₂-C₂₄alkenyl or C₃-C₂₄cycloalkenyl each unsubstituted or substituted by one or more optionally identical or different R₁₈ radicals; or C₆-C₁₂aryl, C₄-C₁₂heteroaryl or C₇-C₁₂aralkyl each unsubstituted or substituted by one or more optionally identical or different R₁₉ radicals; or

R₁ and R₂ together as a pair are C₁-C₂₄alkylene, C₃-C₂₄cycloalkylene, C₂-C₂₄alkenylene, C₃-C₂₄cycloalkenylene or C₇-C₁₂aralkylene each unsubstituted or substituted by one or more optionally identical or different R₁₈ radicals;

R₃, R₄, R₅, R₆, R₉, R₁₀, R₁₁, R₁₂, R₁₃, R₁₄ and R₁₆ are each independently of the others hydrogen, R₁₉, C₁-C₁₂alkyl, C₃-C₁₂cycloalkyl, C₂-C₂₄alkenyl or C₃-C₂₄cycloalkenyl each unsubstituted or substituted by one or more optionally identical or different R₁₈ radicals; or C₆-C₁₂aryl, C₄-C₁₂heteroaryl or C₇-C₁₂aralkyl each unsubstituted or substituted by one or more optionally identical or different R₁₉ radicals; or

R₃ and R₄ and/or R₅ and R₆, and R₉ and R₁₀ and/or R₁₁ and R₁₂, in each case together as a pair, are 1,4-buta-1,3-dienylene unsubstituted or substituted by one or more optionally identical or different R₁₉ radicals, with the result that together with the common phenyl a naphthyl is formed;

it being possible for two, three or more compounds of formula (I), (II), (III) or (IV) to be bonded by direct bonds or by —NH—, —NR₁₅—, —O—, —CO—, —S—, —SO—, —SO₂—, C₁-C₁₂alkylene or C₃-C₁₂cycloalkenylene bridges between their respective substituents R₁ and/or R₂, R₃ and/or R₄, or R₉ and/or R₁₀;

R₁₇ is hydrogen, C₁-C₁₂alkoxy, C₃-C₁₂cycloalkoxy, C₁-C₁₂alkylthio, C₃-C₁₂cycloalkylthio, nitro, cyano, formyl, C₁-C₁₂alkyl, C₃-C₁₂cycloalkyl, C₂-C₁₂alkenyl or C₃-C₁₂cycloalkenyl each unsubstituted or substituted by one or more optionally identical or different halogen, hydroxy, C₁-C₁₂alkoxy or C₃-C₁₂cycloalkoxy radicals; or C₆-C₁₂aryl, C₄-C₁₂heteroaryl or C₇-C₁₂aralkyl each unsubstituted or substituted by one or more optionally identical or different R₁₉ radicals;

R₁₈ is halogen, hydroxy, O—R₂₀, O—CO—R₂₀, S—R₂₀, amino, NH—R₂₀, NR₂₀R₂₁, NR₂₀—CO—R₂₂, NR₂₀COOR₂₂, cyano, formyl, CO—R₂₀, COO—R₂₀, carboxy, carbamoyl, CONH—R₂₀, CONR₂₀R₂₁, ureido, NR₂₀—CO—NHR₂₂, phosphato, PR₂₀R₂₂, POR₂₀OR₂₂, P(═O)OR₂₀OR₂₂, OPR₂₀R₂₂, OPR₂₀OR₂₂, OP(═O)R₂₀OR₂₂, OP(═O)OR₂₀OR₂₂, OPO₃R₂₀, sulfato or sulfo; or C₁-C₁₂alkoxy or C₁-C₁₂cycloalkoxy each mono- or poly-substituted by halogen;

R₁₉ is halogen, nitro, cyano, hydroxy, O—R₂₃, O—CO—R₂₃, S—R₂₃, formyl, CH═C(CN)₂, CH═C(CN)CONH₂, CH═C(CN)CONHR₂₃, CH═C(CN)CONR₂₃R₂₄, CH═C(CN)COOR₂₃, CH═C(COOR₂₃)COOR₂₄, amino, NHR₂₃, NR₂₃R₂₄, CONH₂, CONHR₂₃, CONR₂₃R₂₄, SO₂C₁-C₁₂alkyl, SO₂NHR₂₃, SO₂NHR₂₃, SO₂NR₂₃R₂₄, COOH, COR₂₃, COOR₂₃, NHCOR₂₃, NR₂₃COR₂₅, NHCOOR₂₃, NR₂₃COOR₂₅, ureido, NR₂₃—CO—NHR₂₅, phosphato, PR₂₃R₂₅, POR₂₃OR₂₅, P(═O)OR₂₃OR₂₅, OPR₂₃R₂₅, OPR₂₃OR₂₅, OP(═O)R₂₃OR₂₅, OP(═O)OR₂₃OR₂₅, OPO₃R₂₃, sulfato or sulfo; or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more optionally identical or different R₁₈ radicals;

R₂₀, R₂₁, and R₂₂ are each independently of the others C₁-C₁₂alkyl, C₃-C₁₂cycloalkyl, C₂-C₁₂alkenyl, C₃-C₁₂cycloalkenyl, C₆-C₁₂aryl, C₄-C₁₂heteroaryl or C₇-C₁₂aralkyl; or

R₂₀ and R₂₁, together with the common nitrogen, are pyrrolidine, piperidine, piperazine or morpholine each unsubstituted or mono- to tetra-substituted by C₁-C₄alkyl;

R₂₃, R₂₄ and R₂₅ are each independently of the others C₁-C₁₂alkyl, C₃-C₁₂cycloalkyl, C₂-C₁₂alkenyl or C₃-C₁₂cycloalkenyl each unsubstituted or substituted by one or more optionally identical or different halogen, hydroxy, C₁-C₁₂alkoxy or C₃-C₁₂cycloalkoxy radicals; or C₆-C₁₂aryl, C₄-C₁₂heteroaryl or C₇-C₁₂aralkyl each unsubstituted or substituted by one or more optionally identical or different R₂₆ radicals; or

R₂₃ and R₂₄, together with the common nitrogen, are pyrrolidine, piperidine, piperazine or morpholine each unsubstituted or mono- to tetra-substituted by C₁-C₄alkyl; or carbazole, phenoxazine or phenothiazine each unsubstituted or substituted by one or more optionally identical or different R₂₆ radicals;

R₂₆ is R₁₈ or is C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more optionally identical or different R₁₈ radicals; and

m is a number from 1 to 10.

Provided they are not counterions X⁻ of the compounds of formula (I), (II), (III) or (IV), it will be understood that acid groups, such as carboxy, sulfo, sulfato and phosphato, may also be in the form of salts, for example alkali metal, alkaline earth metal, ammonium or phosphonium salts, such as Li⁺, Na⁺, K⁺, Mg²⁺, Ca²⁺, Cu²⁺, Ni²⁺, Fe²⁺, Co²⁺, Zn²⁺, Sn²⁺, La³⁺, ammonium, methylammonium, ethylammonium, isopropylammonium, pentadecylammonium, dicyclohexylammonium, tetramethylammonium, tetraethylammonium, tetrabutylammonium, benzyltrimethylammonium, benzyltriethylammonium, methyltrioctylammonium, tridodecylmethylammonium, tetrabutylphosphonium, tetraphenylphosphonium, butyltriphenylphosphonium or ethyltriphenylphosphonium, or also any of the cations B-1 to B-180 mentioned in U.S. Pat. No. 6,225,024, to which individual cations reference is expressly made here.

Halogen is chlorine, bromine, fluorine or iodine, preferably fluorine or chlorine, especially fluorine on alkyl (for example trifluoromethyl, α,α,α-trifluoroethyl or perfluorinated alkyl groups, such as heptafluoropropyl) and chlorine on aryl, heteroaryl or on the aryl moiety of aralkyl.

Alkyl, cycloalkyl, alkenyl or cycloalkenyl may be straight-chain or branched, or also monocyclic or polycyclic. Alkyl is, for example, methyl, straight-chain C₂-C₂₄alkyl or preferably branched C₃-C₂₄alkyl. Alkenyl is, for example, straight-chain C₂-C₂₀alkenyl or preferably branched C₃-C₂₄alkenyl. The invention accordingly relates especially also to compounds of formula (I), (II), (III) or (IV) containing branched C₃-C₂₄alkyl or branched C₃-C₂₄alkenyl, and to optical recording materials comprising such compounds. C₁-C₂₄Alkyl is accordingly, for example, methyl, ethyl, n-propyl, isopropyl, n-butyl, sec-butyl, isobutyl, tert-butyl, n-pentyl, 2-pentyl, 3-pentyl, 2,2-dimethylpropyl, n-hexyl, n-octyl, 1,1,3,3-tetramethylbutyl, 2-ethylhexyl, nonyl, decyl, dodecyl, tetradecyl, hexadecyl, octadecyl, eicosyl, heneicosyl, docosyl or tetracosyl. C₃-C₂₄Cycloalkyl is, for example, cyclopropyl, cyclobutyl, cyclopentyl, cyclohexyl, trimethylcyclohexyl, menthyl, thujyl, bornyl, 1-adamantyl or 2-adamantyl.

C₂-C₂₀Alkenyl and C₁-C₂₀cycloalkenyl are C₂-C₂₀alkyl and C₃-C₂₀cycloalkyl respectively, each of which is mono- or poly-unsaturated, wherein two or more double bonds may optionally be isolated or conjugated, for example vinyl, allyl, 2-propen-2-yl, 2-buten-1-yl, 3-buten-1-yl, 1,3-butadien-2-yl, 2-cyclobuten-1-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, 2-cyclopenten-1-yl, 2-cyclohexen-1-yl, 3-cyclohexen-1-yl, 2,4-cyclohexadien-1-yl, 1-ρ-menthen-8-yl, 4(10)-thujen-10-yl, 2-norbornen-1-yl, 2,5-norbornadien-1-yl, 7,7-dimethyl-2,4-norcaradien-3-yl or the various isomers of hexenyl, octenyl, nonenyl, decenyl, dodecenyl, tetradecenyl, hexadecenyl, octadecenyl, eicosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl.

C₇-C₁₈Aralkyl is, for example, benzyl, 2-benzyl-2-propyl, β-phenyl-ethyl, 9-fluorenyl, α,α-dimethylbenzyl, ω-phenyl-butyl, ω-phenyl-octyl, ω-phenyl-dodecyl or 3-methyl-5-(1′,1′,3′,3′-tetramethyl-butyl)-benzyl. C₇-C₂₄Aralkyl may furthermore also be, for example, 2,4,6-tri-tert-butyl-benzyl or 1-(3,5-dibenzyl-phenyl)-3-methyl-2-propyl. When C₇-C₁₈aralkyl is substituted, substitution may be on either the alkyl or the aryl moiety of the aralkyl group, the latter alternative being preferred.

C₆-C₁₄Aryl is, for example, phenyl, naphthyl, biphenylyl, 2-fluorenyl, phenanthryl, anthracenyl or terphenylyl.

C₄-C₁₂Heteroaryl is an unsaturated or aromatic radical having 4n+2 conjugated π-electrons, for example 2-thienyl, 2-furyl, 2-pyridyl, 2-thiazolyl, 2-oxazolyl, 2-imidazolyl, isothiazolyl, triazolyl or any other desired ring system consisting of thiophene, furan, pyridine, thiazole, oxazole, imidazole, isothiazole, triazole, pyridine and benzene rings that is unsubstituted or substituted by from 1 to 6 ethyl, methyl, ethylene and/or methylene.

In addition, aryl and aralkyl may also be aromatic groups bonded to a metal, for example in the form of transition metal metallocenes, known per se, more especially

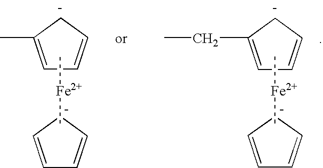

X⁻ as an inorganic, organic or organometallic anion is, for example, the anion of a mineral acid, the conjugate base of an organic acid (for example an alcoholate, phenolate, carboxylate, sulfonate or phosphonate) or an organometallic complex anion, for example fluoride, chloride, bromide, iodide, perchlorate, periodate, nitrate, ½ carbonate, hydrogen carbonate, ½ sulfate, C₁-C₄alkyl sulfate, hydrogen sulfate, ⅓ phosphate, ½ hydrogen phosphate, dihydrogen phosphate, ½ C₁-C₄alkane phosphonate, C₁-C₄alkane-C₁-C₁₂alkyl phosphonate, di-C₁-C₄alkyl phosphinate, tetrafluoroborate, hexafluorophosphate, hexafluoroantimonate, acetate, trifluoroacetate, heptafluorobutyrate, ½ oxalate, methanesulfonate, trifluoromethanesulfonate, tosylate, benzenesulfonate, p-chlorobenzenesulfonate, p-nitrobenzenesulfonate, phenolate, benzoate or a negatively charged metal complex.

The person skilled in the art will readily recognise that it is also possible to use other anions known to him. 1/x of an inorganic, organic or organometallic anion having x negative charges, for example ½·SO₄²⁻, will be understood as an anion having a charge of more than 1 that neutralises a plurality of cations having a charge of 1 or, as appropriate, also a cation having x charges.

Phenolates or carboxylates are, for example, of the formula

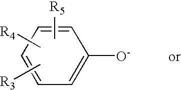

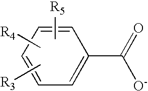

(wherein R₃, R₄ and R₅ are as defined for formula (I) or (II) but have meanings that are independent of R₃, R₄ and R₅ in formula (I) or (II), for example anions of C₁-C₁₂-alkylated, especially tert-C₄-C₈-alkylated, phenols and benzoic acids, such as

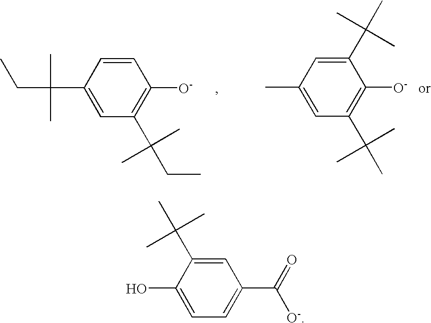

X⁻ as a metal complex is preferably an anion of formula [(L₁)M₁(L₂)]^{m-} (V) or [(L₃)M₂(L₄)]⁻ (VI), wherein M₁ and M₂ are each a transition metal, M₁ preferably being Cr³⁺ or Co³⁺ and M₂ preferably being Ni²⁺, Co²⁺ or Cu²⁺, m is a number from 1 to 6, L₁ and L₂, each independently of the other(s), are ligands of formula

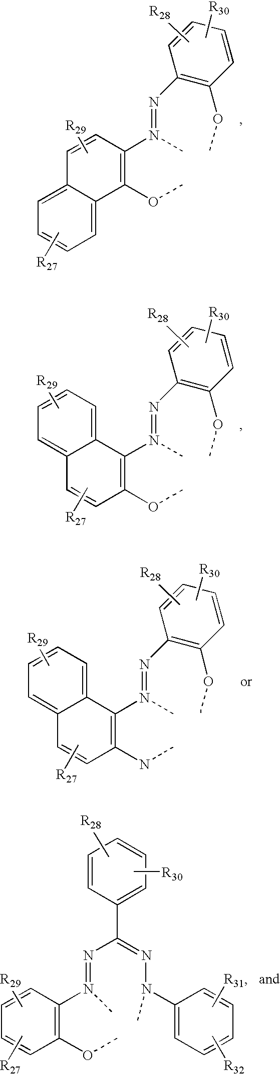

L₃ and L₄, each independently of the other(s), are ligands of formula

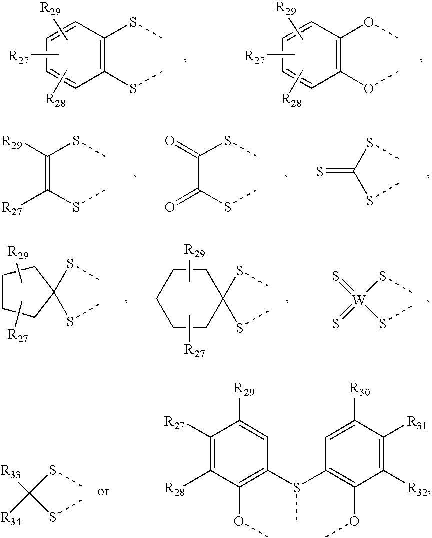

in which formulae R₂₇, R₂₈, R₂₉, R₃₀, R₃₁ and R₃₂ are each independently of the others hydrogen, halogen, cyano, R₃₅, NO₂, NR₃₅R₃₆, NHCO—R₃₅, NHCOOR₃₅, SO₂—R₃₅, SO₂NH₂, SO₂NHR₃₅, SO₂NR₃₅R₃₆, SO₃⁻ or SO₃H, preferably hydrogen, chlorine, SO₂NH₂ or SO₂NHR₃₅, wherein R₃₅ and R₃₆ are each independently of the other C₁-C₁₂alkyl, C₁-C₁₂alkoxy-C₂-C₁₂alkyl, C₇-C₁₂aralkyl or C₆-C₁₂aryl, preferably C₁-C₄alkyl, each unsubstituted or substituted by hydroxy, halogen, sulfato, C₁-C₆alkoxy, C₁-C₆alkylthio, C₁-C₆alkylamino or di-C₁-C₆alkylamino, and R₃₃ and R₃₄ are each independently of the other CN, CONH₂, CONHR₃₅, CONR₃₅R₃₆, COOR₃₅ or COR₃₅.

By way of illustration, but without implying any limitation, reference is made to the individual compounds disclosed in U.S. Pat. No. 5,219,707, JP-A-06/199045 and JP-A-07/262604.

In addition, it is possible to use any other known transition metal complex anions that contain, for example, a phenolic or phenylcarboxylic azo compound as ligand L₁ or L₂.

Preference is given to compounds of formula (I), (II), (III) or (IV) wherein A₁ and A₂ are each independently of the other N(R₁₅), O, S or unsubstituted or R₁₆-substituted CH═CH;

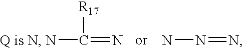

R₃, R₄, R₅, R₆, R₉, R₁₀, R₁₁, R₁₂, R₁₃, R₁₄ and R₁₆ are each independently of the others hydrogen, R₁₉, or C₆-C₁₂aryl or C₇-C₁₂aralkyl each unsubstituted or substituted by one or more optionally identical or different R₁₉ radicals;

R₁₇ is hydrogen, cyano, C₁-C₁₂alkyl unsubstituted or substituted by one or more halogens, or C₆-C₁₂aryl unsubstituted or substituted by one or more optionally identical or different R₁₉ radicals;

R₁₈ is halogen, hydroxy, O—R₂₀, amino, NH—R₂₀, NR₂₀R₂₁, NR₂₀—CO—R₂₂, NR₂₀COOR₂₂, cyano, COO—R₂₀, carboxy, CONH—R₂₀, CONR₂₀R₂₁, sulfato or sulfo, or C₁-C₁₂alkoxy unsubstituted or mono- or poly-substituted by halogen;

R₁₉ is halogen, nitro, cyano, O—R₂₃, formyl, CH═C(CN)₂, CH═C(CN)CONH₂, CH═C(CN)CONHR₂₃, CH═C(CN)CONR₂₃R₂₄, CH═C(CN)COOR₂₃, CH═C(COOR₂₃)COOR₂₄, CONH₂, CONHR₂₃, CONR₂₃R₂₄, SO₂C₁-C₁₂alkyl, SO₂NH₂, SO₂NHR₂₃, SO₂NR₂₃R₂₄, COOH, COOR₂₃, NHCOR₂₃, NR₂₃COR₂₅, NHCOOR₂₃, NR₂₃COOR₂₅, ureido, P(═O)OR₂₃OR₂₅ or sulfo; or C₁-C₁₂alkyl, C₁-C₁₂alkylthio or C₁-C₁₂alkoxy each unsubstituted or substituted by one or more optionally identical or different R₁₈ radicals;

R₂₀, R₂₁ and R₂₂ are each independently of the others C₁-C₁₂alkyl, C₂-C₁₂alkenyl, C₆-C₁₂aryl or C₇-C₁₂aralkyl; or

R₂₀ and R₂₁, together with the common nitrogen, are morpholine, or piperidine N-substituted by C₁-C₄alkyl;

R₂₃, R₂₄ and R₂₅ are each independently of the others C₁-C₁₂alkyl unsubstituted or substituted by one or more optionally identical or different halogen, hydroxy or C₁-C₁₂alkoxy radicals, or unsubstituted C₆-C₁₂aryl or C₇-C₁₂aralkyl; or

R₂₃ and R₂₄, together with the common nitrogen, are morpholine, or piperidine N-substituted by C₁-C₄alkyl; and

m is a number from 1 to 4.

Special preference is given to compounds of formula (I), (II), (III) or (IV) wherein A₁ and A₂ are each S and Q is N or

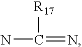

R₁, R₂, R₇, R₈ and R₁₅ are each independently of the others C₁-C₂₄alkyl, C₁-C₄alkyl-[O—C₁-C₄alkylene]ₘ or C₁-C₄alkyl-[NH—C₁-C₄alkylene]ₘ each unsubstituted or substituted by one or more optionally identical or different R₁₈ radicals, or C₆-C₁₂aryl unsubstituted or substituted by one or more optionally identical or different R₁₉ radicals; or

R₁ and R₂ together as a pair are C₁-C₂,alkylene unsubstituted or substituted by one or more optionally identical or different R₁₈ radicals;

R₁₇ is hydrogen, cyano, C₁-C₁₂alkyl unsubstituted or substituted by one or more halogens, or phenyl unsubstituted or substituted by one or more optionally identical or different R₁₉ radicals;

R₁₈ is halogen, hydroxy, O—R₂₀, cyano, COO—R₂₀, carboxy, sulfato or sulfo; and R₁₉ is halogen, nitro, cyano, O—R₂₃, CH═C(CN)₂, COOR₂₃, ureido, P(═O)OR₂₃OR₂₅ or sulfo.

Compounds of formula (I) or (III) are preferred, with compounds of formula (I) being especially preferred.

The recording layer advantageously comprises a compound of formula (I), (II), (III) or (IV) or a mixture of such compounds as the main component, for example at least 30% by weight, especially at least 60% by weight, more especially at least 80% by weight. Further customary constituents are possible, for example other chromophores (for example those disclosed in WO-01/75873, or any others having an absorption maximum at from 300 to 1000 nm), stabilisers, ¹O₂-, triplet- or luminescence-quenchers, melting point reducers, decomposition accelerators, or any other additives that have already been described in optical recording media. Preferably, stabilisers or fluorescence quenchers are optionally added.

When the recording layer contains further chromophores, the amount of those chromophores should preferably be so small that the absorption thereof at the wavelength of the inversion point of the longest-wavelength flank of the absorption characteristic of the solid layer as a whole is, at the same wavelength, a fraction, advantageously no more than ⅓, especially no more than ⅕, more especially no more than 1/10, of the absorption of the pure compound of formula (I), (II), (III) or (IV) in the solid layer as a whole. The absorption maximum is preferably higher than 425 nm, especially higher than 500 nm.

Stabilisers, ¹O₂-, triplet- or luminescence-quenchers are, for example, metal complexes of N- or S-containing enolates, phenolates, bisphenolates, thiolates, bisthiolates or of azo, azomethine or formazan dyes, such as bis(4-dimethylamino-dithiobenzil)nickel [CAS N° 38465-55-3], ®Irgalan Bordeaux EL, ®Cibafast N or similar compounds, hindered phenols and derivatives thereof (optionally also as counterions X), such as ®Cibafast AO, o-hydroxyphenyl-triazoles, -triazines or other UV absorbers, such as ®Cibafast W or ®Cibafast P or hindered amines (TEMPO or HALS, also as nitroxides or NOR-HALS, optionally also as counterions X), further as cations diimmonium, Paraquat™ or Orthoquat™ salts, such as Kayasorb IRG 022, ®Kayasorb IRG 040, optionally also as free radical ions, such as N,N,N′,N′-tetrakis(4-dibutyl-aminophenyl)-p-phenyleneamine-ammonium hexafluorophosphate, hexafluoroantimonate or perchlorate. The latter are obtainable from Organica (Wolfen/DE), ®Kayasorb brands are obtainable from Nippon Kayaku Co., Ltd. and ®Irgalan brands and ®Cibafast brands are obtainable from Ciba Spezialitätenchemie AG.

Many such structures are known, some of them in connection with optical recording media, for example from U.S. Pat. No. 5,219,707, JP-A-06/199045, JP-A-07/76169, JP-A-07/262604 or JP-A-2000/272241. They may be, for example, salts of the previously disclosed metal complex anions with any desired cations, for example the previously disclosed cations.

There come into consideration, in addition, neutral metal complexes, for example those of formula (L₃)M₂(L₅) (VII), (L₆)M₂(L₇) (VIII) or M₂(L₈) (IX), wherein L₅ is C₁-C₁₂alkyl-OH, C₃-C₁₂cycloalkyl-OH, C₆-C₁₂aryl-OH, C₇-C₁₂aralkyl-OH, C₁-C₁₂alkyl-SH, C₃-C₁₂cycloalkyl-SH, C₆-C₁₂aryl-SH, C₇-C₁₂aralkyl-SH, C₁-C₁₂alkyl-NH₂, C₃-C₁₂cycloalkyl-NH₂, C₆-C₁₂aryl-NH₂, C₇-C₁₂aralkyl-NH₂, di-C₁-C₁₂alkyl-NH, C₁-C₁₂alkyl-(C₃-C₁₂cycloalkyl)-NH, di-C₃-C₁₂cycloalkyl-NH, di-C₆-C₁₂aryl-NH, di-C₇-C₁₂aralkyl-NH, tri-C₁-C₁₂alkyl-N, tri-C₃-C₁₂cycloalkyl-N, di-(C₁-C₁₂alkyl)-(C₃-C₁₂cycloalkyl)-N, (C₁-C₁₂alkyl)-di-(C₃-C₁₂cycloalkyl)-N, tri-C₆-C₁₂aryl-N or tri-C₇-C₁₂aralkyl-N,

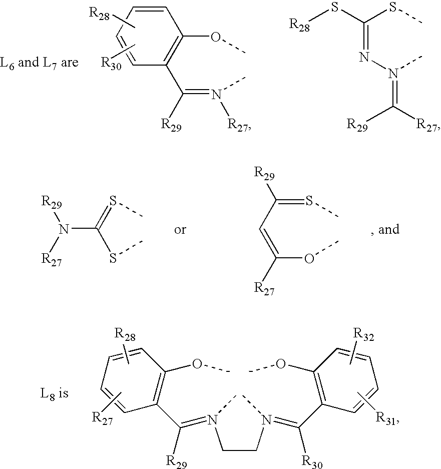

in which formulae M₂ and R₂₇ to R₃₂ have the definitions given hereinbefore.

As a particular example of an additive of formula (IX), copper complexes may be mentioned, illustrated, for example, by the compound of formula

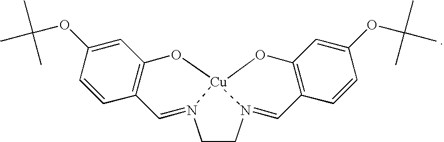

As a particular example of an additive of formula (VII), nickel bisphenolates may be mentioned, illustrated, for example, by the compound of formula

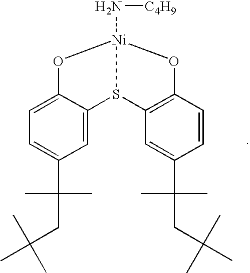

The person skilled in the art will know from other optical information media, or will readily recognise, which additives in which concentration will be especially well suited for which purpose. Suitable concentrations of additives are, for example, from 0.001 to 1000% by weight, preferably from 1 to 50% by weight, based on the recording composition of formula (I), (II), (III) or (IV).

The optical recording materials according to the invention exhibit excellent spectral properties in the solid amorphous recording layer. Owing to a surprisingly low tendency of such compounds to aggregate in the solid material, the absorption band is narrow and intense, having an especially high degree of steepness on the long-wavelength side. Unexpectedly, and very advantageously, dimers are not formed or are formed only to a negligible extent. The reflectivity of the layers in the region of the writing and reading wavelength is high in the unwritten state.

Owing to those excellent layer properties, a rapid optical recording having a high degree of sensitivity, high level of reproducibility and geometrically very precise pit boundaries is possible, the refractive index and the reflectivity being substantially modified, resulting in a high level of contrast. The tolerances on the pit lengths and gap distances (“jitter”) are very small. This allows a high storage density as a result of a comparatively thin recording channel with a relatively small track separation (“pitch”). In addition, the recorded data is played back with astonishingly low error rates, with the result that the error correction requires only a small amount of storage space.

As a result of the excellent solubility, even in apolar solvents, it is also possible to use solutions of high concentration without troublesome precipitation occurring, for example during storage, so that problems during spin coating largely disappear.

Recording and playback can be carried out at the same wavelength. Advantageously, a simple lens with a single laser source of, advantageously, from 350 to 500 nm, preferably from 370 to 450 nm, is used. The wavelength is especially preferably in the UV range from 370 to 390 nm, especially approximately 380 nm, or especially at the margin of the visible range from 390 to 430 nm, especially approximately 405±5 nm. In the range of compact, blue or violet laser diodes (such as Nichia GaN 405 nm) with a lens having a high numerical aperture, it is possible for the pits to be so small and the tracks so narrow that up to approximately 20 to 25 Gb per recording layer can be achieved on a 120 mm disc. At 380 nm, it is possible to use indium-doped UV-VCSELs (Vertical-Cavity Surface-Emitting Laser), such a laser source already exists as a prototype [Jung Han et al., cf. MRS Internet J. Nitride Semicond. Res. 5S1, W6.2 (2000)].

The invention accordingly relates also to a method for the recording or playback of data that comprises recording or playing back the data at a wavelength of from 350 to 500 nm on an optical recording medium according to the invention.

The recording medium is based on the structure of known recording media and is, for example, analogous to those previously mentioned. It may be constructed, for example, from a transparent substrate; a recording layer comprising at least one of the compounds of formula (I), (II), (III) or (IV); a reflector layer; and a covering layer, the writing and reading being carried out through the substrate.

Suitable substrates include, for example, glasses, minerals, ceramics and thermosetting or thermoplastic plastics. Preferred supports are glasses and homo- or co-polymeric plastics. Suitable plastics include, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates, which can be produced, for example, by means of injection-moulding. The substrate may be in pure form or may also comprise customary additives, for example UV absorbers or dyes, as proposed, for example, in JP-A-04/167239 as light stabilisation for the recording layer. In the latter case, it may be that the dye added to the supporting substrate exhibits no absorption or at most a small amount of absorption in the range of the writing wavelength (emission wavelength of the laser), preferably up to a maximum of approximately 20% of the laser light focussed onto the recording layer.

Advantageously, the substrate is transparent over at least a portion of the range from 350 to 500 nm, so that it is permeable to, for example, at least 80% of the light of the writing or reading wavelength incident thereon. The substrate advantageously has a thickness of from 10 μm to 1 mm, especially from 20 to 600 μm, more especially from 20 to 600 μm, with a preferably spiral-shaped guide groove (track) on the coating side, a groove depth of from 10 to 200 nm, preferably from 80 to 150 nm, a groove width of from 100 to 400 nm, preferably from 150 to 250 nm, and a spacing between 2 revolutions of from 200 to 600 nm, preferably from 350 to 450 nm. Grooves of various cross-sectional profiles are known, for example rectangular, trapezium-shaped or V-shaped. Analogously to the known CD-R and DVD-R media, the guide groove may, in addition, undergo a small periodic or quasi-periodic lateral deflection (“wobble”), allowing synchronisation of the speed of rotation and absolute positioning of the reading head (“pick-up”). The same function can be performed, instead of or in addition to the deflection, by markings between adjacent grooves (“pre-pits”).

The recording composition is applied, for example, by spin-coating a solution, the intention being to provide a layer that is as amorphous as possible, the thickness of which on the surface (“land”) is advantageously from 0 to 30 nm, especially from 1 to 20 nm, more especially from 2 to 10 nm, and the thickness of which in the groove, depending on the groove geometry, is advantageously from 20 to 150 nm, especially from 50 to 120 nm, more especially from 60 to 100 nm.

Suitable reflecting materials for the reflector layer are especially metals that readily reflect the laser radiation used for the recording and playback, for example metals of the third, fourth and fifth main groups and of the sub-groups of the periodic table of chemical elements. The following are especially suitable: Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu, as well as alloys thereof. Because of the high level of reflectivity and ease of production, preference is given especially to a reflecting layer of aluminium, silver, gold or an alloy thereof (for example a white gold alloy) and, for economic and ecological reasons, preference is given more especially to aluminium. The reflector layer has a thickness of, advantageously, from 5 to 200 nm, especially from 10 to 100 nm, more especially from 40 to 60 nm, but thicker reflector layers are also possible, for example 1 mm thick or even more.

Suitable materials for the covering layer are mainly plastics, which are applied in a thin layer to the reflector layer either directly or with the aid of adhesion promoters. Advantageously, mechanically and thermally stable plastics having good surface properties that can still undergo modification, for example writing, are selected. The plastics can be either thermosetting or thermoplastic. For directly applied covering layers, preference is given to coatings that are radiation-cured (for example using UV radiation), which are especially simple and economical to produce. A very large number of radiation-curable materials are known. Examples of radiation-curable monomers and oligomers include acrylates and methacrylates of diols, triols and tetrols, polyimides of aromatic tetracarboxylic acids and aromatic diamines having C₁-C₄alkyl groups in at least two positions ortho to the amino groups, and oligomers having dialkylmaleinimidyl groups, for example dimethylmaleinimidyl groups. For covering layers applied by means of adhesion promoters, the same materials as are used for the substrate layer, especially polycarbonates, are preferably used. The adhesion promoters used are likewise preferably radiation-curable monomers and oligomers. Instead of the covering layer applied by means of an adhesion promoter, it is possible to use a second substrate comprising recording layer and reflector layer, with the result that the recording medium can be played on both sides. Preference is given to a symmetrical structure in which the two parts are joined to one another, on the reflector side, directly by means of an adhesion promoter, or by way of an intermediate layer.

In that form of structure, the optical properties per se of the covering layer, or of the covering materials, essentially play no part except that curing thereof may, where appropriate, be carried out by means of, for example, UV radiation. The main function of the covering layer is to ensure the mechanical strength of the recording medium as a whole and, if necessary, the mechanical strength of thin reflector layers. Where the recording medium is adequately stable, for example when a thick reflector layer is present, it may even be possible to dispense with the covering layer completely. The thickness of the covering layer depends on the thickness of the recording medium as a whole, which should preferably be a maximum of approximately 2 mm. The covering layer preferably has a thickness of from 10 μm to 1 mm.

The recording media according to the invention may also have additional layers, for example interference layers or barrier layers. It is also possible for recording media to be constructed with a plurality of (for example from two to ten) recording layers. The structure and the use of such materials are known to the person skilled in the art. Preference is given, where appropriate, to interference layers that are arranged between the recording layer and the reflecting layer and/or between the recording layer and the substrate and that consist of a dielectric material, for example, of TiO₂, Si₂N₄, ZnS or silicone resins, as described in EP-A-0 353 393.

The recording media according to the invention can be prepared according to methods known per se, it being possible for various coating methods to be used depending on the materials employed and their mode of operation.

Suitable coating methods include, for example, immersion, pouring, brushing, knife coating, and spin-pouring, as well as vapour deposition methods, which are carried out in high vacuum. When, for example, pouring methods are used, solutions in organic solvents are generally employed. When solvents are used, it must be ensured that the supports employed are not sensitive to those solvents. Suitable coating methods and solvents are described, for example, in EP A-0 401 791.

The recording layer is preferably applied by spin-coating a dye solution, solvents that have proved especially suitable being alcohols, for example 2-methoxyethanol, isopropanol or n-butanol, hydroxyketones, for example diacetone alcohol or 3-hydroxy-3-methyl-2-butanone, hydroxy esters, for example lactic acid methyl ester or isobutyric acid methyl ester, or preferably fluorinated alcohols, for example 2,2,2-trifluoroethanol or 2,2,3,3-tetrafluoro-1-propanol, and mixtures thereof. Further suitable solvents are described, for example, in EP A-0 483 387.

Compounds of formula (I), (II), (III) or (IV) comprising one or more unsaturated, non-aromatic bonds may also be polymerised, alone or together with other polymerisable monomers, such as just for example acrylics and vinylics. Polymerisation is preferably accomplished after coating of a polymerisable compound or mixture.

Thus, the invention also pertains to an optical recording medium comprising a substrate, a recording layer and a reflecting layer, wherein the recording layer comprises a polymer obtained from homo- or copolymerisation of a compound of formula (I), (II), (III) or (IV) comprising an unsaturated, non-aromatic carbon-carbon bond.

The metallic reflector layer is preferably applied by atomization (sputtering) or by vapour deposition in vacuo. Those techniques are known and are described in specialised books (for example J. L. Vossen and W. Kern, “Thin Film Processes”, Academic Press, 1978). The procedures can advantageously be carried out continuously, and good reflectivity as well as a high level of adhesion of the metallic reflector layer is achieved.

The recording is carried out according to known methods by writing pits (marks) of fixed or variable length by means of a modulated, focussed laser beam guided at constant or variable speed over the surface of the recording layer. The information is read according to methods known per se by registering the variation in reflection using laser radiation, for example as described in “CD-Player und R-DAT Recorder” (Claus Biaesch-Wiepke, Vogel Buchverlag, Würzburg 1992). The requirements are known to the person skilled in the art.

The information-containing medium according to the invention is especially an optical information material of the WORM type. It can be used, for example, analogously to CD-R (compact disc-recordable) or DVD-R (digital video disc-recordable) in computers, and also as storage material for identity cards and security cards or for the manufacture of diffractive optical elements, for example holograms. Compared with CD-R or DVD-R, however, the manufacturing procedure is considerably more tricky. In order to produce recording media having high storage density and correspondingly small pits, a covering layer of thickness about 50 to 400 μm (typically 100 μm for a numeric aperture of 0.85) has now proved to be necessary for accurate focussing.

An inverse layer structure, in which the layer sequence is substrate, reflector layer, recording layer and covering layer, is accordingly preferred. The recording layer is thus located between the reflector layer and the covering layer. Recording and playback are therefore carried out not through the substrate, but through the covering layer. Compared with the previously described structure, the respective roles of the covering layer and the substrate, especially the geometry and the optical properties, are thus switched. A number of corresponding concepts are described in Proceedings SPIE-Int. Soc. Opt. Eng. 1999, 3864 for digital video recordings in conjunction with a blue GaN laser diode.

It has now been found that the inverse layer structure places substantially higher demands on the recording substances, those demands being surprisingly well met by the compounds used in accordance with invention. It is thus possible, without appreciable changes to the solid recording layer, to apply thereto a thin covering layer under which the recording substances are adequately protected from friction, photo-oxidation, finger prints, humidity and other environmental effects.

In the inverse layer structure, the recording and reflector layers in principle have the same function as specified before. They accordingly have the same dimensions.

Especially preferably there is applied to the solid recording layer an additional thin separating layer of a metallic, crosslinked organometallic or dielectric inorganic material, for example in a thickness of from 0.001 to 10 μm, especially from 0.005 to 1 μm, more especially from 0.01 to 0.1 μm. In view of their high level of reflectivity, metallic separating layers should advantageously have a maximum thickness of 0.03 μm.

Crosslinked organometallic or dielectric inorganic layers are known per se and consist of, for example, oxides, hydrated oxides or halides (especially fluorides), metals having an electronegativity of from 1 to 2, for example aluminum, zinc, zirconium, titanium, chromium, iron, cobalt, nickel and, more especially, silicon, in a degree of oxidation of from II to V, such as CaF₂, Fe₂O₃, CoO, CoTiO₃, Cr₂O₃, Fe₂TiO₅ or SiO₂. They can be applied according to or analogously to known methods, for example by cathodic pulverisation, vapour deposition, chemical vapour deposition or also, for some layers, by wet-chemical methods known for that purpose, described, for example, in WO 93/08237 and in further references mentioned therein. General methods for vapour deposition, cathodic pulverisation or chemical vapour deposition are very well known to the person skilled in the art. Those methods are advantageously carried out in vacuo, the pressure during the coating procedure being from 10⁻¹ to 10⁻⁸ Pa. Metal oxides, with the exception of silicon oxides, are preferably vapour-deposited at a pressure of from 1.3·10⁻² to 1.3·10⁻³ Pa.

It will be understood that further coating methods known to the person skilled in the art can also be used. For example, coatings can be prepared by the sol/gel techonology known from EP 504 926, JP-A-07/207186, JP-A-08/175823, JP-A-09/239311 and JP-A-10/204296, or silicon oxide coatings can also be prepared from SiH₄ by thermal decomposition.

Silicon oxides are especially advantageously applied by vapour deposition of metallic silicon in the presence of oxygen. For vapour deposition, silicon, which need not necessarily be pure, is heated under reduced pressure in the vicinity of the substrate to be coated, in the presence of gaseous (molecular) oxygen, which also need not necessarily be pure, to a high temperature, for example from 500° C. to 2000° C., by means of induction or using electron guns. There are formed silicon sub-oxides that are to a greater or lesser extent yellow to dark-grey coloured, or, preferably, colourless silicon dioxide, depending on the relative molar concentration of the oxygen.

It is possible, especially, for layers that are identical or analogous to the isolating layers in rewritable optical recording media based on metal alloys (CD-RW), for example those consisting of a mixture of SiO₂ and ZnS, to be applied. As a result, the development can be accelerated and it is possible to dispense with new investments for the coating procedure.

It may prove advantageous, prior to further coating, to treat the recording layer with an adhesion promoter, for example N-(3-(trimethoxysilyl)-propyl)pyrrole known from J. Amer. Chem. Soc. 104, 2031-4 (1982) and Chemistry of Materials 9/2, 399-402 (1997), titanium or zirconium salts, such as Ti(OiPr)₄ or Zr(acac)₄, and/or acids or bases, such as ammonia or primary, secondary or tertiary amines. Preference is given to the simultaneous use of an amine of formula

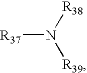

wherein R₃₇ is hydrogen or R₄₀, R₃₈ and R₃₉ are each independently of the other R₄₀, and R₄₀ is [-1,2-C₂-C₃alkylene-T-]ₙ-H wherein T is O or NH and n is a number from 1 to 3, and organometallic compounds of formula

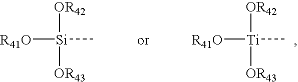

wherein R₄₁ to R₄₃ are C₁-C₄alkyl.

In that case, a molar ratio of amine to organometallic compound of from 10:1 to 1000:1, a temperature of from −20 to 150° C., especially from 20 to 80° C., and a duration of treatment of from ¼ hour to 100 hours, are preferred, with special preference being given to a molar ratio of amine to organometallic compound of from 50:1 to 250:1, a temperature of from 50 to 80° C. and a duration of treatment of from 1 to 10 hours.

If desired, such coatings can, for example, be applied in the same thickness also between the supporting material and the metallic reflector layer, or between the metallic reflector layer and the optical recording layer. In some cases this can lead to advantages, for example when a silver reflector is used in combination with sulfur-containing additives in the recording layer.

Instead of or also in addition to inorganic or crosslinked organometallic layers, it is also possible to use layers of a polymer, which are applied, for example, by polymerisation, especially by photopolymerisation, or alternatively by lamination.

Especially advantageously, there may be applied by polymerisation or lamination, over the inorganic or crosslinked organometallic layer, a covering layer having the thickness and optical properties disclosed hereinabove.

The invention accordingly relates also to an optical recording medium comprising, in the following arrangement,

a) a supporting material consisting of a reflecting metal or, preferably, of a polymer having a reflecting metallic layer;

b) an optical recording layer;

c) a separating layer consisting of a metallic, crosslinked organometallic or dielectric inorganic substance; and

d) a covering layer.

Most of the compounds used in accordance with the invention are known or can be prepared analogously to known compounds according to known processes, for example those disclosed or referred to in Liebigs Ann. Chem 647, 11 (1961), Liebigs Ann. Chem 663, 96 (1963), Chimia 20, 318-323 (1966), J. Indian Chem. Soc. 47/12, 1121-1128 (1970), U.S. Pat. No. 3,850,645, Liebigs Ann. Chem 1975 373-386 (1975), Bull. Chem. Soc. Japan 51/2, 535-539 (1978) or Helv. Chem. Acta 67/3, 770-773 (1984).

It is also possible, however, in accordance with or analogously to the same processes known per se, to prepare novel compounds that can be used in accordance with the invention in optical recording media.

The invention accordingly relates also to compounds of formula (I), (II), (III) or (IV), with the exception of the compounds that are already known such as

a compounds of formula (I) wherein Q is N, A₁ and A₂ are both S, R₁ and R₂ are unsubstituted linear C₁-C₁₈alkyl or with hydroxy or sulfo substituted linear C₁-C₃alkyl, and R₃ and R₅ are both H, halogen or OR₂₃, or a salt thereof;

compounds of formula (I) wherein Q is N or P, A₁ and A₂ are both N(R₁₅), R₁ and R₂ are each C₁-C₂alkyl or together C₁-C₃alkylene, R₃, R₄, R₅ and R₆ are all hydrogen, and R₁₅ is C₁-C₂alkyl; and

compounds of formula (III) wherein Q is N, A₁ and A₂ are both S, R₁ and R₂ are both methyl, R₁₀ and R₁₂ are both unsubstituted phenyl, and R₉ and R₁₁ are both hydrogen.

New compounds particularly suitable for the purpose of the inventions are:

compounds of formula (I) wherein A₁ and A₂ are both S and R₁ and R₂ are each independently of the other C₃-C₂₄cycloalkyl, C₁-C₄alkyl-[O—C₁-C₄alkylene]ₘ, C₁-C₄alkyl-[NH—C₁-C₄alkylene]ₘ, C₂-C₂₄alkenyl, C₃-C₂₄cycloalkenyl, C₁-C₁₂aralkyl or branched C₃-C₂₄alkyl;

compounds of formula (I) wherein A₁ and A₂ are both S and R₃, R₄, R₅ and/or R₆ is C₁-C₁₂alkyl;

compounds of formula (I) wherein A₁ and A₂ are both S and comprise a radical R₁₈ which is halogen, O—R₂₀, cyano, CO—R₂₀ or COO—R₂₀, or a radical R₁₉ which is S—R₂₃ or SO₂C₁-C₁₂alkyl;

compounds of formula (I) wherein A₁ and A₂ are both N(R₁₅) and R₃, R₄, R₅ or R₆ is a radical R₁₉ selected from the group consisting of halogen, O—R₂₃, O—CO—R₂₃, S—R₂₃, amino, NHR₂₃ and NR₂₃R₂₄, in which compounds R₁, R₂ and/or R₁₅ is preferably C₁-C₂₄alkyl, in particular C₁-C₂alkyl;

compounds of formula (III) wherein A₁ and A₂ are both S and R₁, R₂ or R₁ and R₂ is C₂-C₂₄alkyl, C₃-C₂₄cycloalkyl, C₁-C₄alkyl-[O—C₁-C₄alkylene]ₘ, C₂-C₂₄alkenyl or C₃-C₂₄cycloalkenyl; or R₁ and R₂ together as a pair are C₂-C₂₄alkylene;

compounds of formula (III) wherein A₁ and A₂ are both S and R₉, R₁₀, R₁₁ and/or R₁₂ is hydrogen, R₁₉, C₁-C₁₂alkyl or C₆-C₁₂aryl unsubstituted or substituted by one or more optionally identical or different R₁₉ radicals, and R₁₉ is halogen, nitro, cyano, O—R₂₃ or SO₂C₁-C₁₂alkyl;

in which compounds Q is in each case preferred N.

Also very suitable are the new compounds of formula (I), (II), (III) or (IV) comprising a transition metal metallocene moiety, preferably

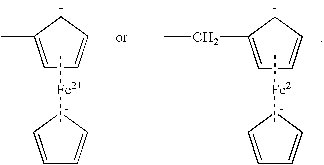

The following Examples illustrate the invention without limiting the scope thereof (unless indicated otherwise, “%” is always % by weight):

### EXAMPLE 1

(see Zeitschrift für Naturforschung A24(11), 1829 Table 1 e) [1969]).

1.0 g of the compound of formula

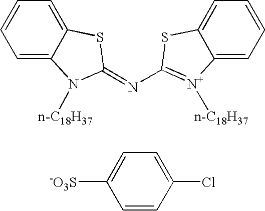

is dissolved in 99.0 g of 2,2,3,3-tetrafluoro-1-propanol and filtered through a 0.2 μm Teflon filter. The clear solution is then applied at 250 revs/min to a 0.6 mm-thick grooved polycarbonate disc (diameter 120 mm, groove spacing 0.74 μm, groove depth 0.17 μm, groove width 0.34 μm) and spin coated at 1000 revs/min, with the result that a uniform solid layer is formed. After drying, the solid layer has an absorbance of 0.75 at 365 nm. A 65 nm-thick reflector layer of silver is then applied. Subsequently, a UV-crosslinkable photopolymer (650-020, DSM) is applied in a thickness of 5 μm by spin coating and is crosslinked using UV light. The absorption maximum of the solid layer (λₘₐₓ) is at 366 nm. At 405 nm the recording layer has a reflectivity of 42%. Using a pulsed dye laser (pulse length 15 ns), pits are written into the recording layer at a wavelength of 405 nm with an energy density of 0.8 kJ/m², resulting in a change in reflection from 42% to 20% at the written locations.

### EXAMPLES 2-34

The following compounds are used analogously to Example 1:

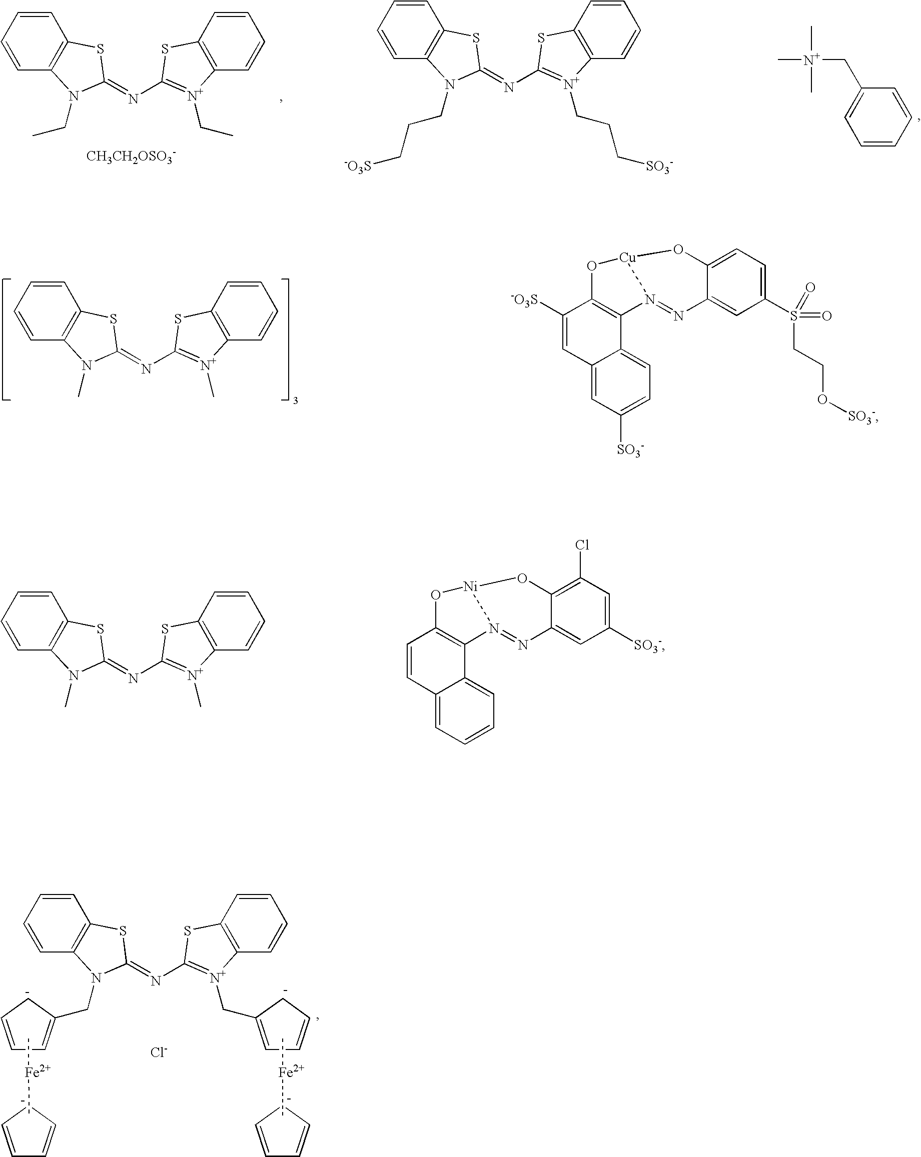

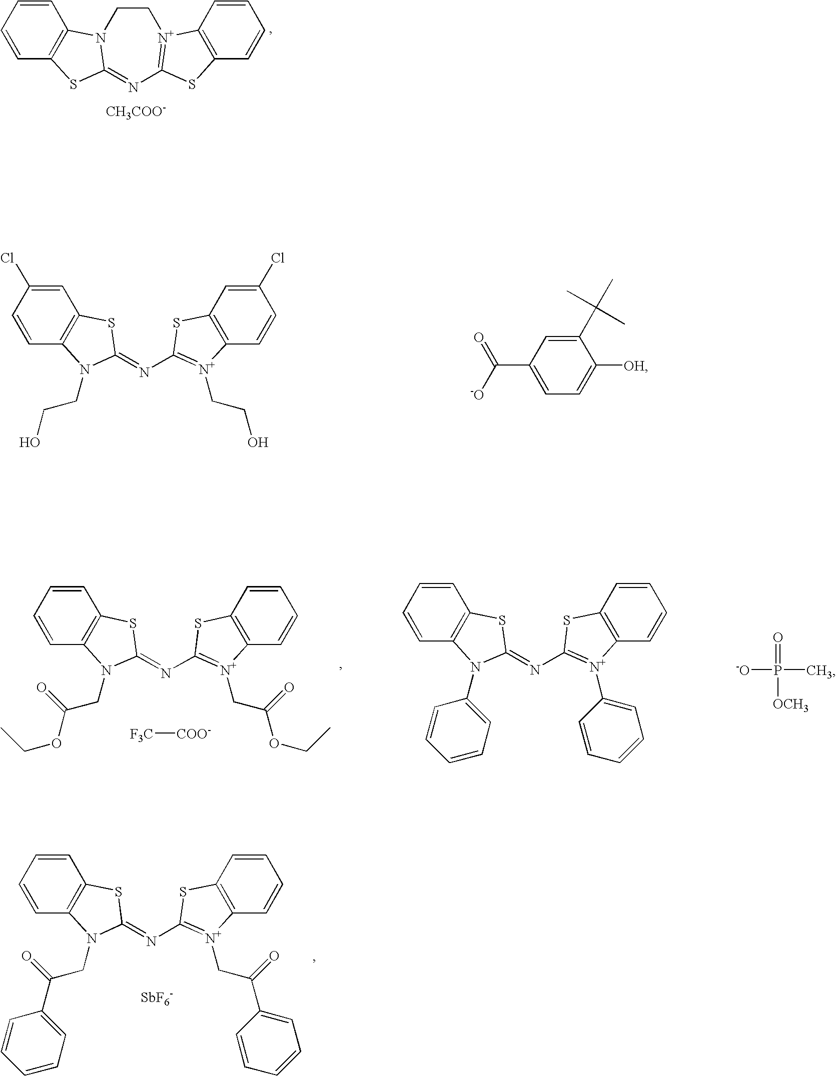

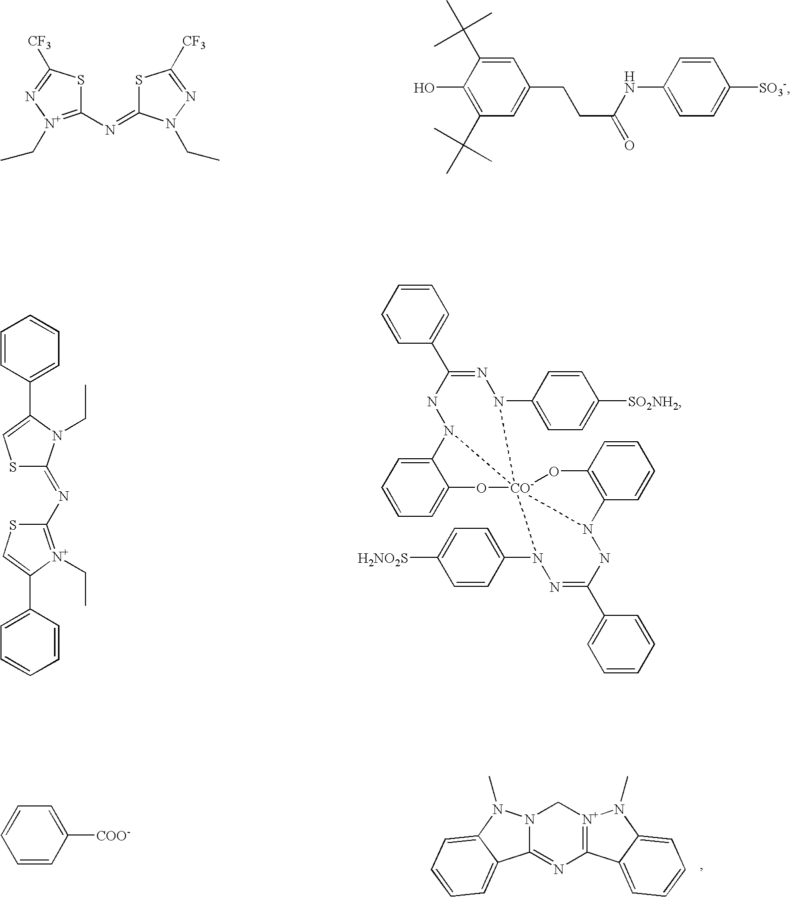

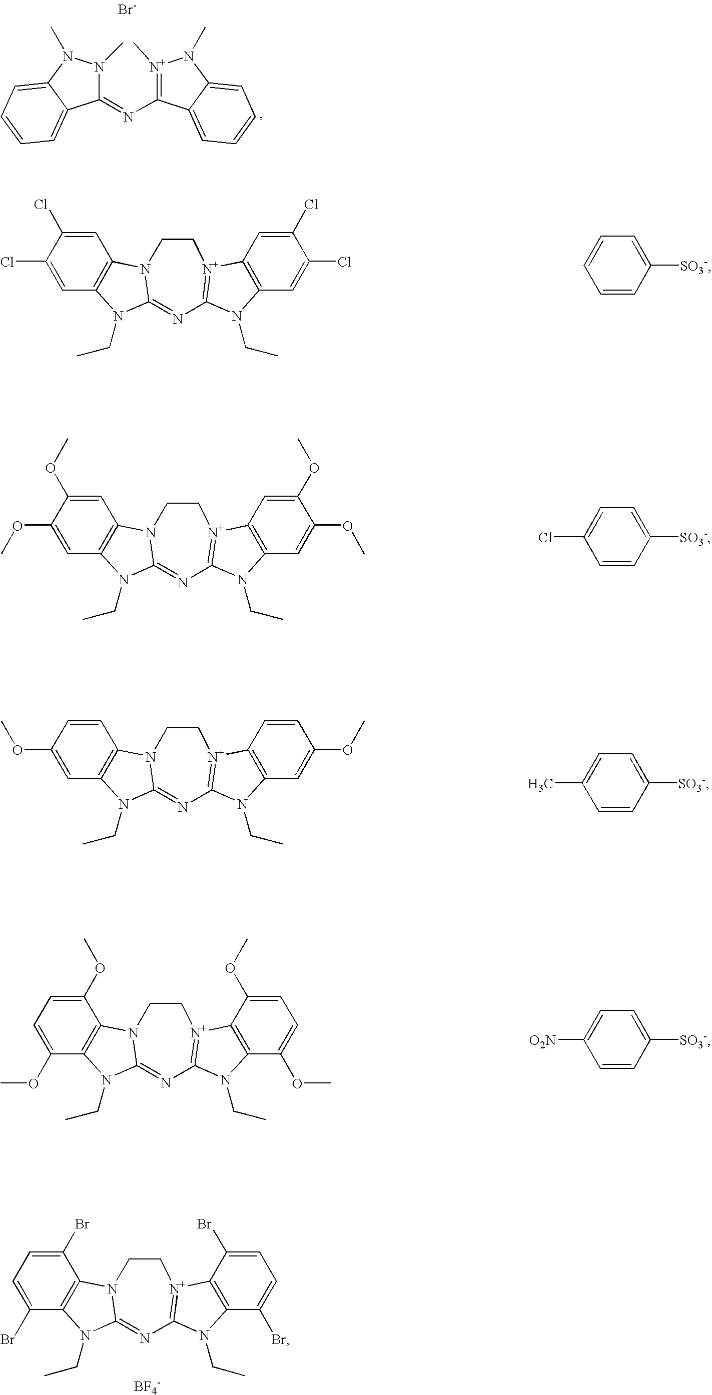

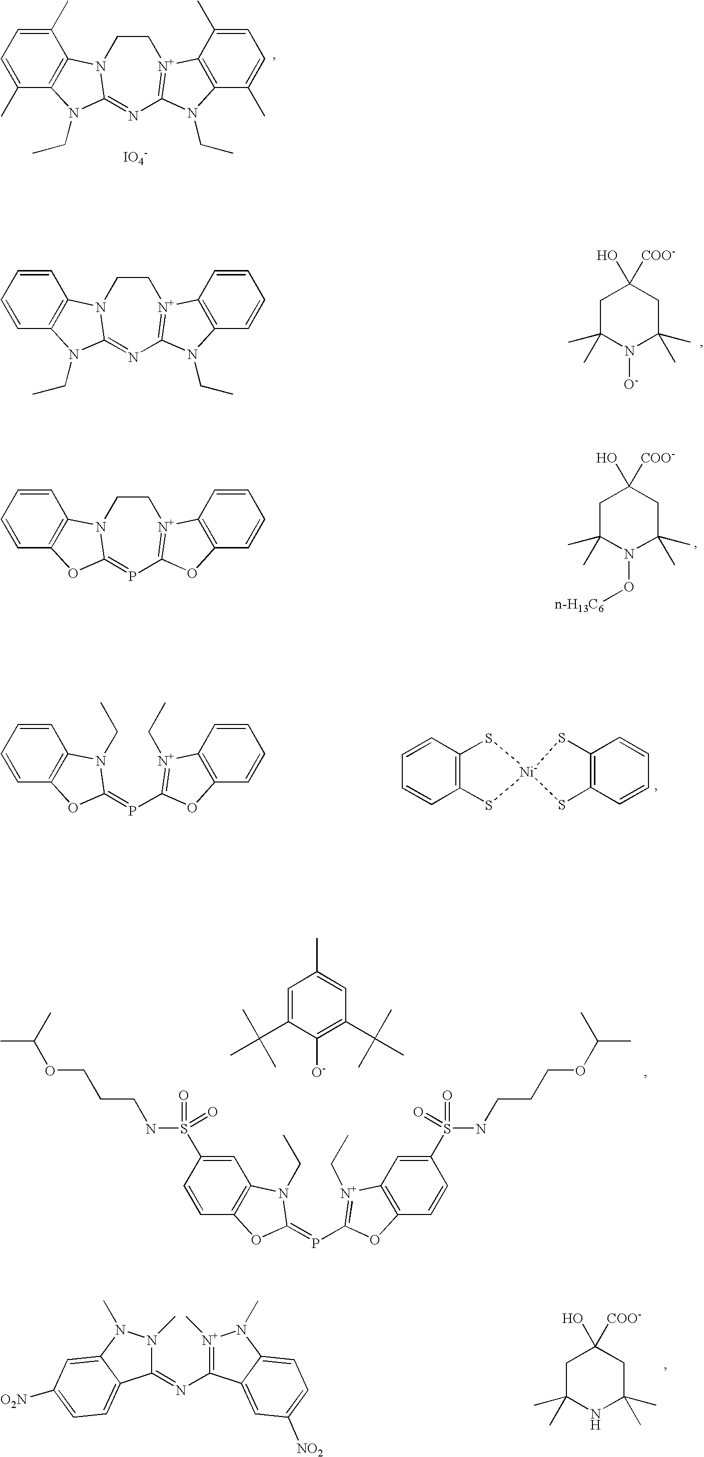

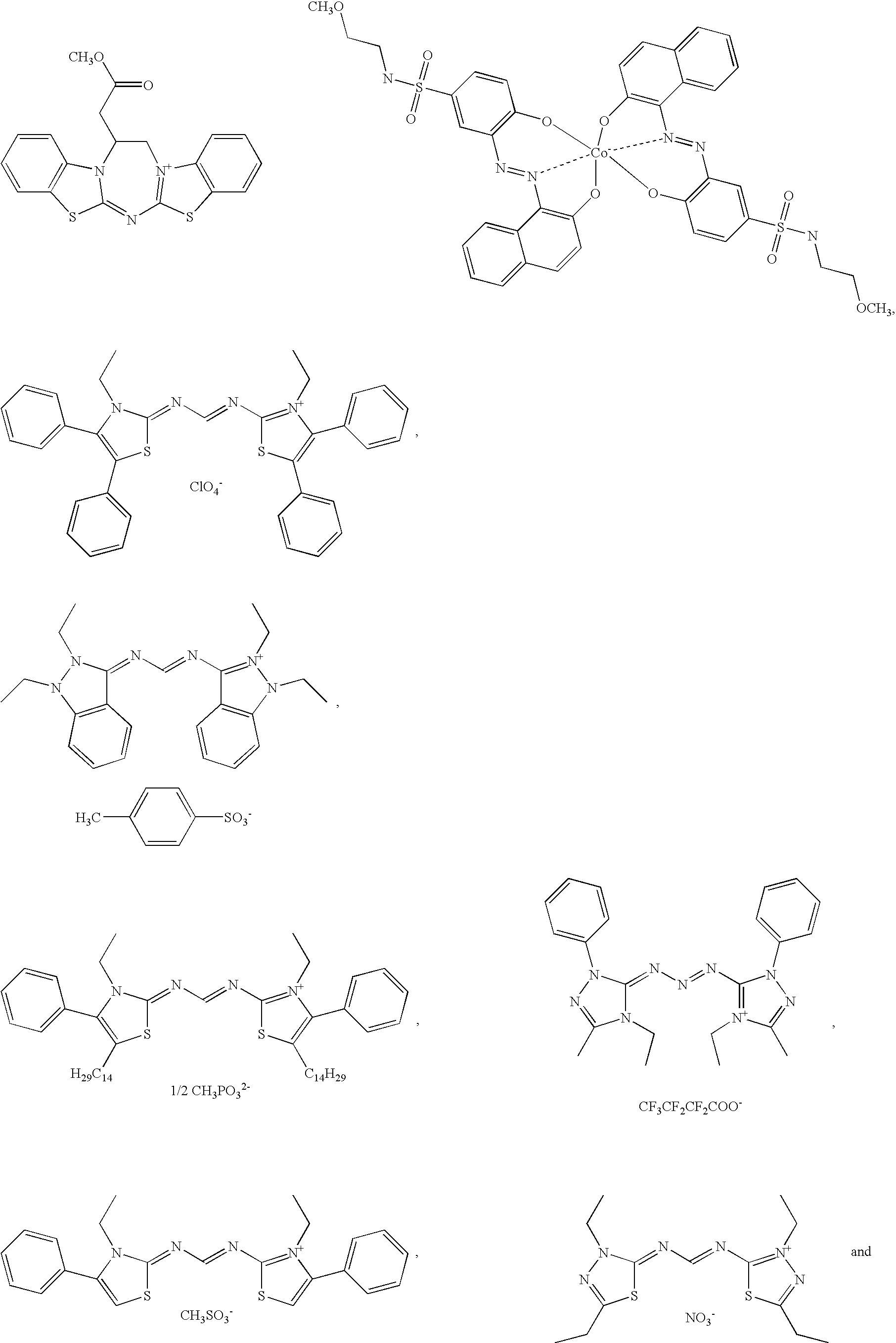

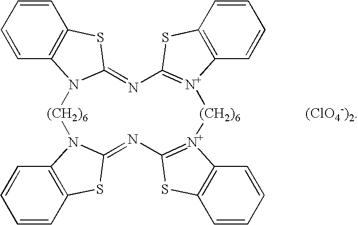

### EXAMPLES 35-40

The homologous or open-chain compounds 7a, 7b, 27d, 27e, 7z and 32 from the dissertation by Marcel H. Luchsinger “Synthese, Spektroskopie und Hydrolyse von 3,3′-n-Methylen-bis-(benzthiazol)-azamonomethincyanin-perchloraten” [“Synthesis, spectroscopy and hydrolysis of 3,3′-n-methylene-bis-(benzothiazole)-azamonomethinecyanine perchlorates”] (Basle University 1971) are used analogously to Example 34.

### EXAMPLES 41-52

The following compounds are used analogously to Example 1:

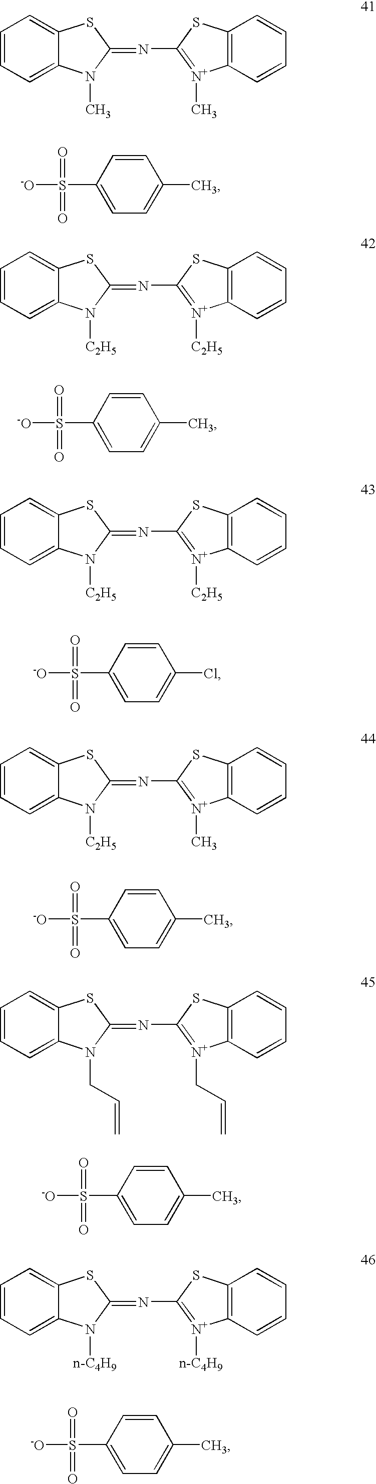

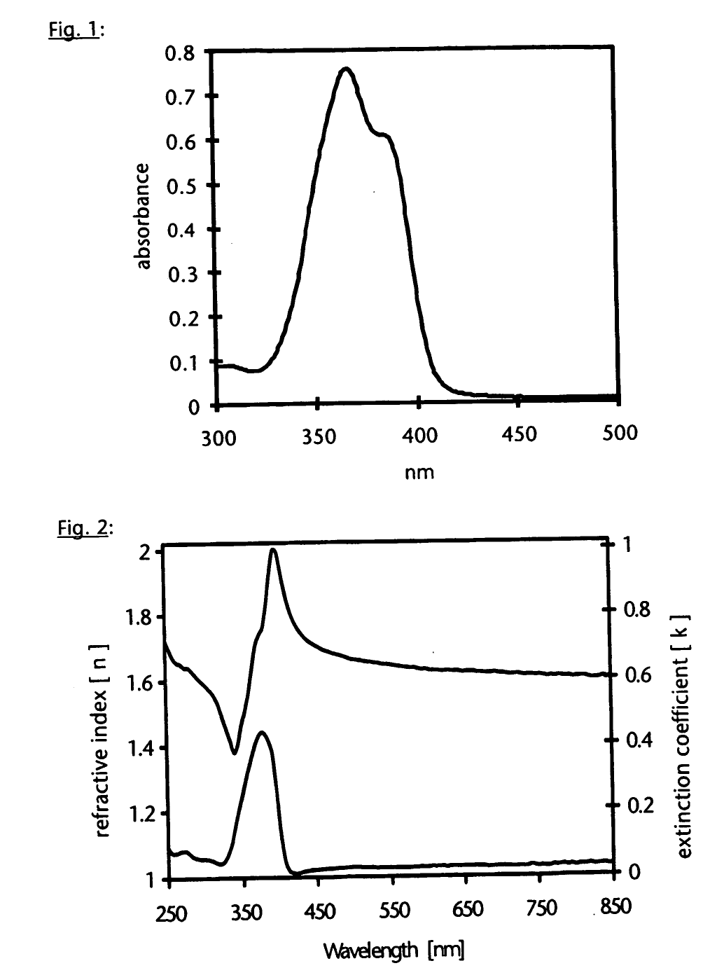

(FIG. 1 shows the solid film UV/VIS spectrum of the recording disc according to this Example),

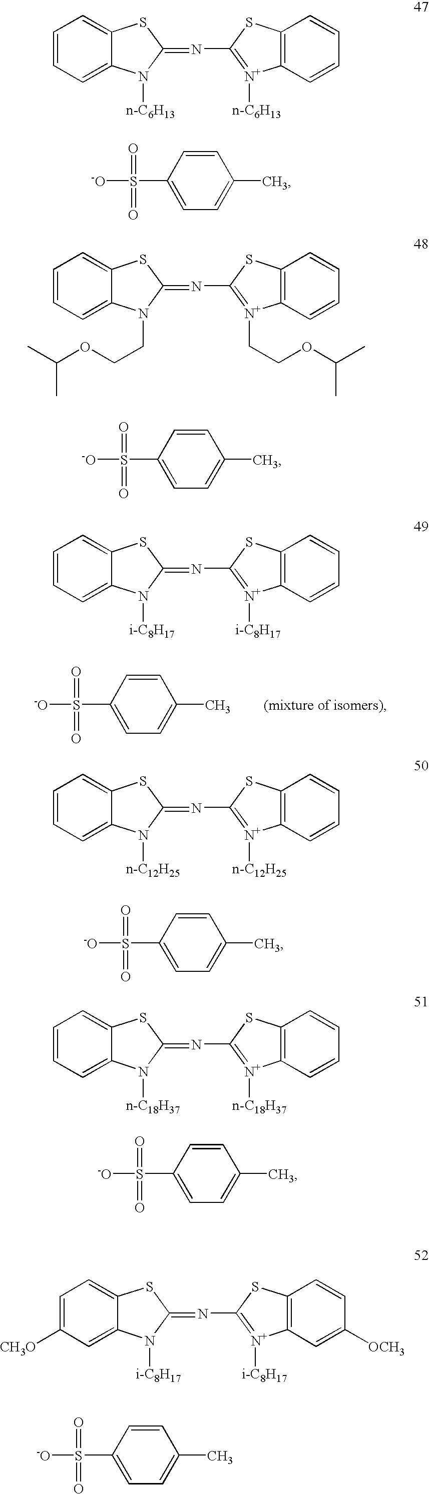

(mixture of isomers).

### EXAMPLE 53

Instead of the asymmetrical compound according to Example 44, a 1:1 mixture of the two symmetrical compounds according to Examples 41 and 42 is used.

### EXAMPLE 54

a) 3.0 parts of 2-amino-benzothiazole and 7.7 parts of (3′,3′-dimethyl-butyl-1′)-4-methyl-benzenesulfonate are heated to 130° C. for 100 minutes. Acetone is added and the solid product is filtered off and dried.

b) After addition of 60 parts of a 5% solution of sodium hydrogencarbonate, the resulting suspension is heated to 80° C. for 2 hours. After cooling to room temperature 30 parts of diethylether are added. The ether phase is separated, dried and evaporated.

c) A mixture of 0.52 parts p-toluenesulfonic acid and 36 parts of o-dichlorobenzene is heated to boiling for 1 hour to distill off water and cooled to 75° C. After addition of the product from b) temperature is raised to 178° C. for 90 minutes. After cooling to room temperature ether is added and the solid formed is collected by filtration. After recrystallization from acetone the colourless crystals are dried at 40° C. The compound of formula

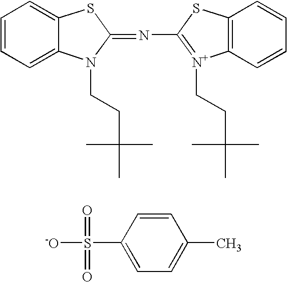

is obtained.

Melting point: 225-226° C.; UV/VIS (ethanol): λₘₐₓ=379 nm, ε=48418 I.mol⁻¹.cm⁻¹.

### EXAMPLE 55

1.0% by weight of the compound according to Example 54 is dissolved in 2,2,3,3-tetrafluoro-1-propanol and filtered through a 0.2 μm Teflon filter. The dye solution is then applied to a 0.6 mm thick flat polycarbonate disc (diameter 120 mm) at 1000 revs/min and spin coating is subsequently carried out at 1500 revs/min. A uniform solid layer is obtained which, after drying, has an absorbance of 0.33 at λₘₐₓ 366 nm. The layer thickness and the refractive index are evaluated using an optical measuring system (ETA-RT, Steag Hamatech). The solid dye layer has a thickness of 36 nm, and at 405 nm has a refractive index n of 1.96 and an extinction coefficient k of 0.083. By varying the solvent, concentration and spin coating conditions, it is possible to make layers of different thicknesses, for example a 88.5 nm thick layer, the refractive index n (upper line, left scale) and extinction coefficient k (underneath line, right scale) of which are shown in FIG. 2.

### EXAMPLE 56

0.187 parts of the compound from example 54 c) are dissolved in 15 parts of ethanol. A solution of 0.216 parts of the cobalt complex of structure

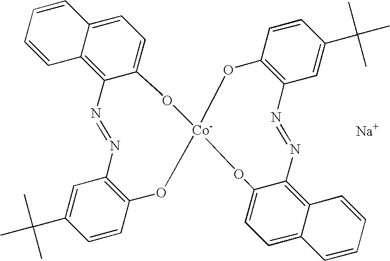

in 12 parts of ethanol is then added. After filtration the combined solutions are evaporated to dryness. The residue is dissolved in 14 parts of dichloromethane and the resulting solution is washed 4 times with 5 parts of water. The dichloromethane phase is then filtered, evaporated to dryness and further dried in vacuo at room temperature. 0.304 parts of the ion pair of the following structure are obtained:

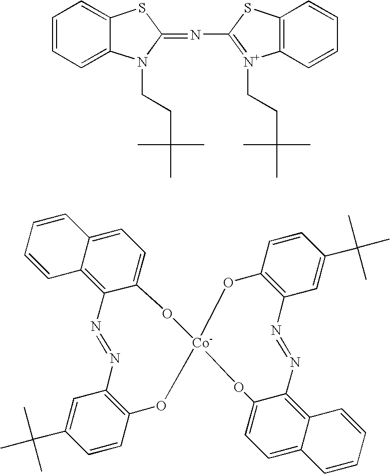

1.5% by weight of this compound is dissolved in 2,2,3,3-tetrafluoro-1-propanol and filtered through a 0.2 μm Teflon filter. The dye solution is then applied to a 1.2 mm thick flat polycarbonate disc (diameter 120 mm) at 600 revs/min and spin coating is subsequently carried out at 1500 revs/min. A uniform solid layer is obtained which, after drying, has an absorbance of 0.49 at λₘₐₓ 372 nm. The layer thickness and the refractive index are evaluated using an optical measuring system (ETA-RT, Steag Hamatech). The solid dye layer has a thickness of 110 nm, and at 405 nm has a refractive index n of 1.86 and an extinction coefficient k of 0.102.

The lightstability of this material is excellent upon accelerated irradiation with xenon light for 90 hours.

### EXAMPLES 57-76

The following compounds are used analogously to Examples 54-56:

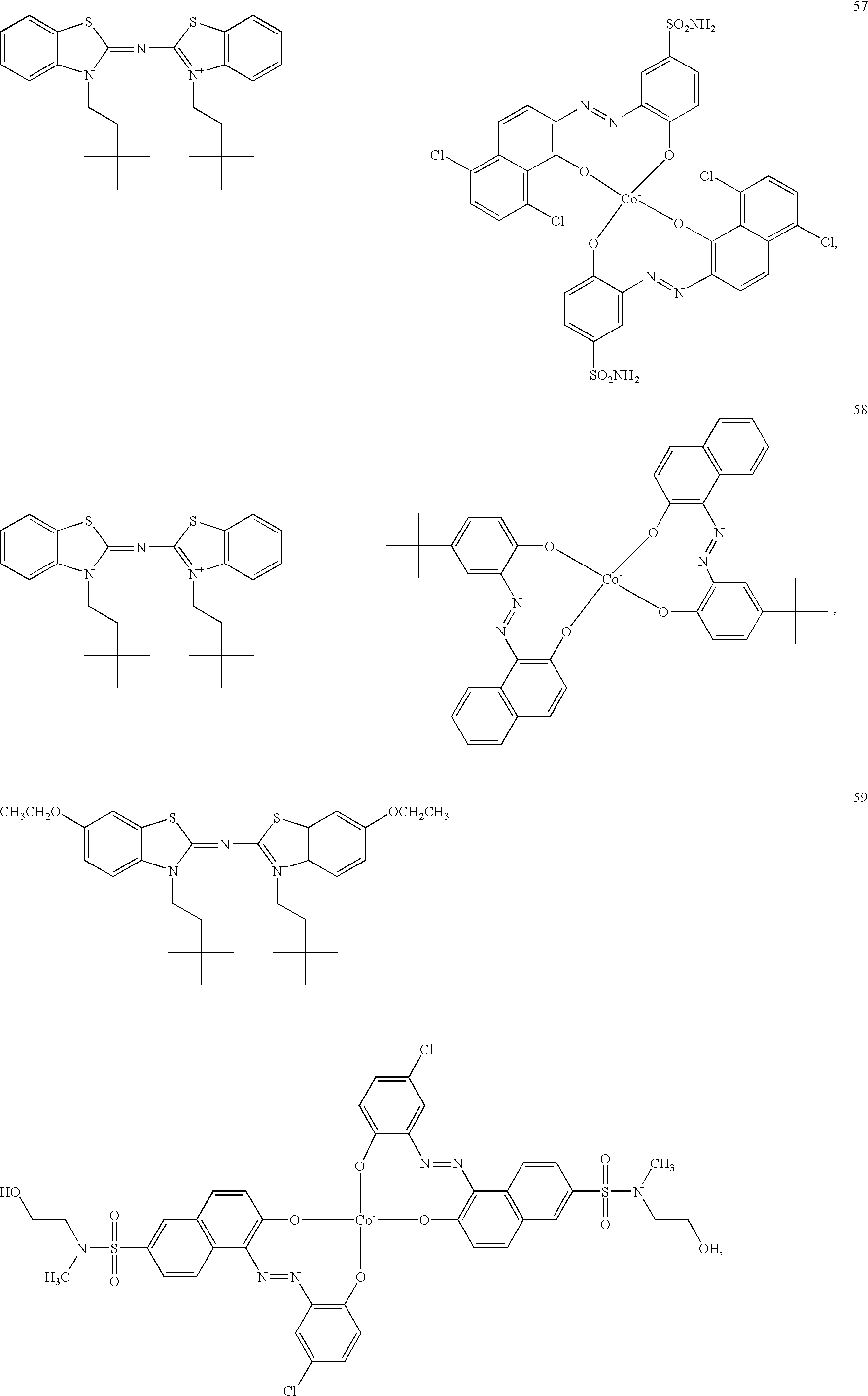

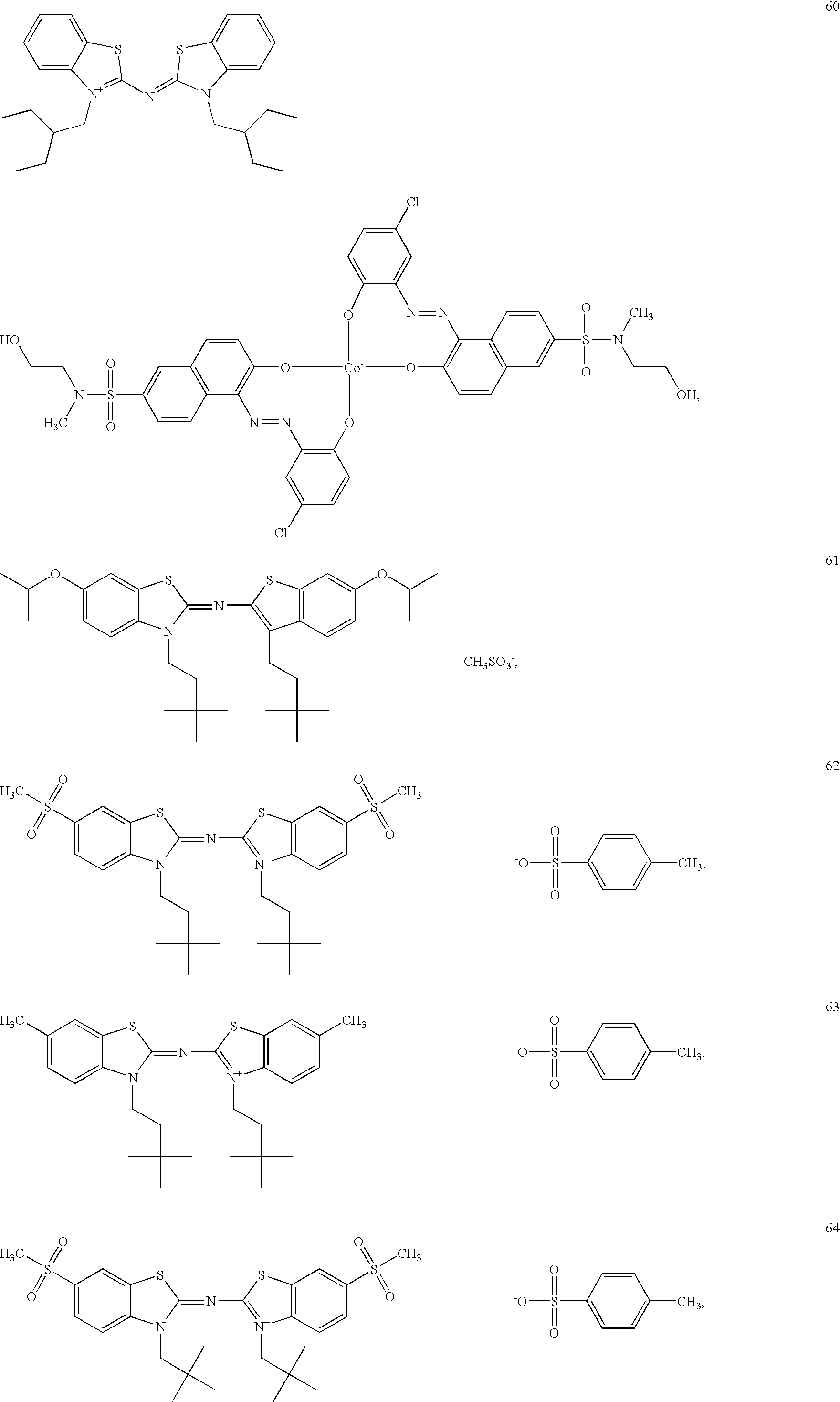

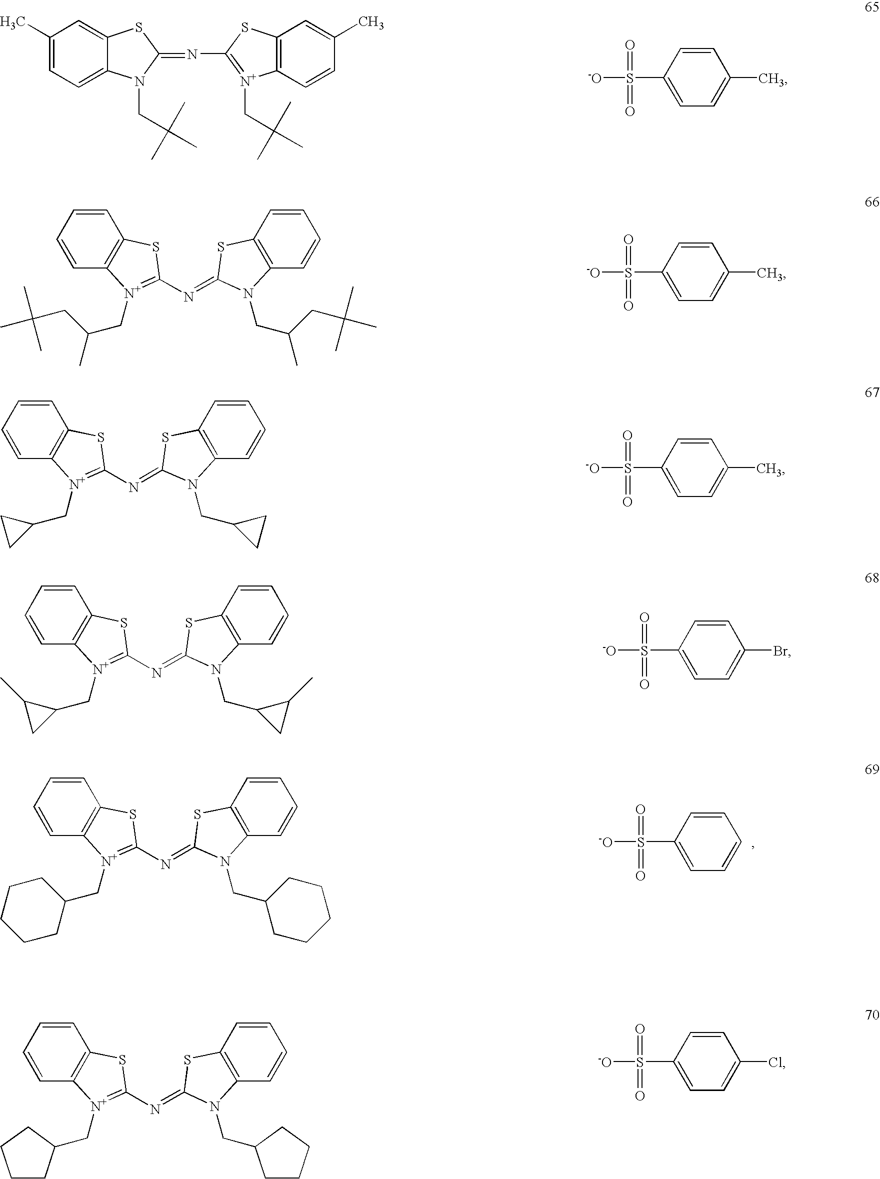

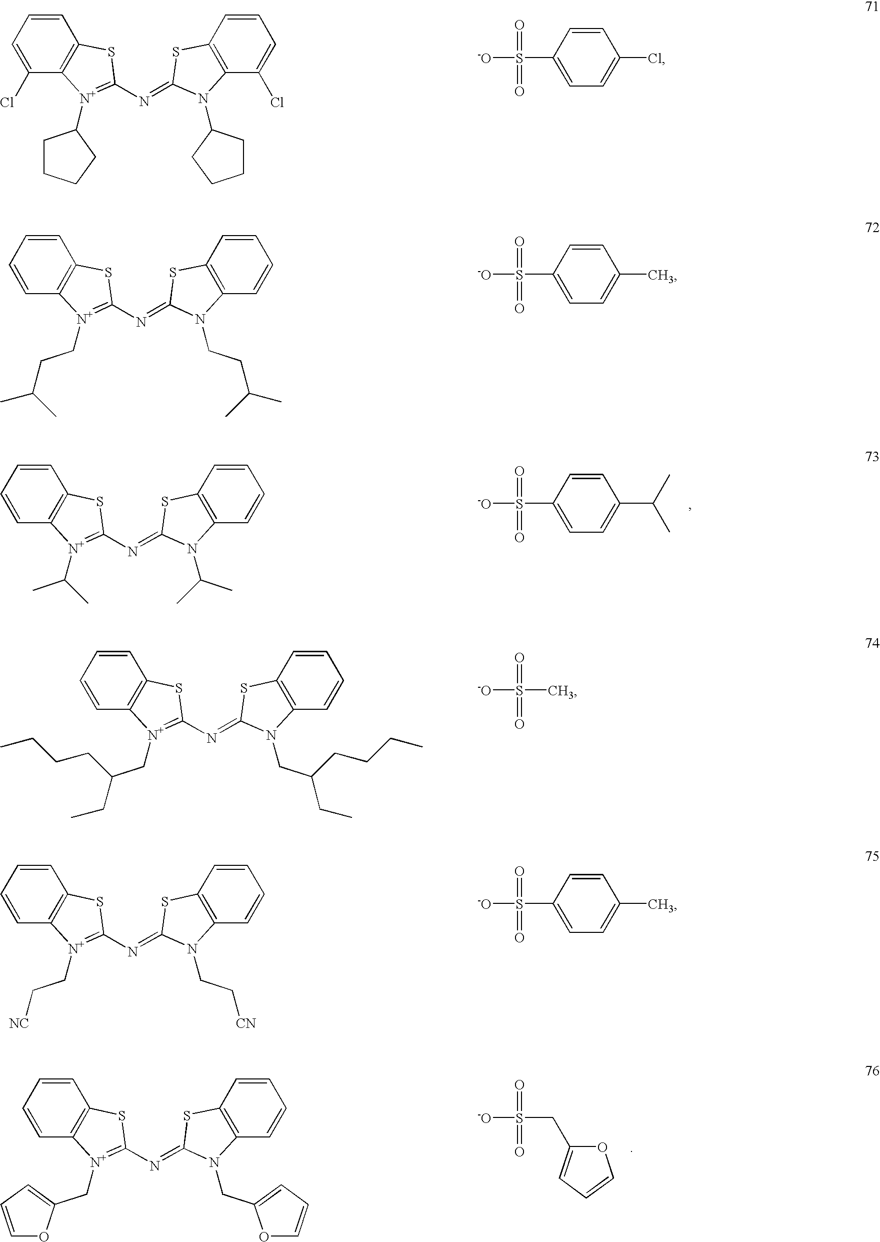

### EXAMPLES 77-88

The spectral data of the solid layers according to some of the above Examples are compared with the spectral data of the corresponding compound in pure ethanol solution:

| | | | | UV/VIS in solution | |
|---|---|---|---|---|---|
| | | | | (ethanol) | |
| Exam- | According | in solid layer | | | ε [l · mol⁻¹ · |
| ple | to | State | λₘₐₓ [nm] | λₘₐₓ [nm] | cm⁻¹] |
| 77 | 41 | crystalline | | 376 | |
| 78 | 42 | amorphous | 361 | 377 | |
| 79 | 43 | | 365 | 377 | |
| 80 | 45 | | 367 | 379 | |
| 81 | 46 | | 367 | 378 | |
| 82 | 47 | | 366 | 378 | 47887 |
| 83 | 48 | | 367 | 380 | 47255 |
| 84 | 49 | | 366 | 379 | 48283 |
| 85 | 50 | | 368 | 378 | 47672 |
| 86 | 51 | | 365 | 379 | 48618 |
| 87 | 53 | crystalline | | 376 | |
| 88 | 54/55 | amorphous | 366 | 379 | 48418 |

What is claimed is:

1. An optical recording medium comprising a substrate, a recording layer and a reflecting layer, wherein the recording layer comprises a compound of formula 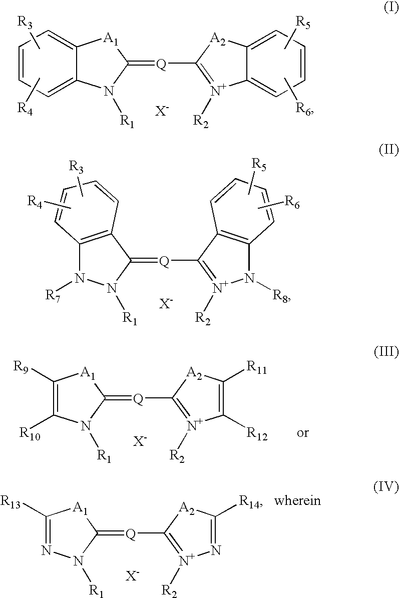
A₁ and A₂ are each independently of the other C(C₁-C₅alkyl)₂, C(C₄-C₅alkylene), N(R₁₅), O, S, Se, or unsubstituted or R₁₆-substituted CH═CH; 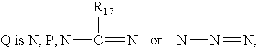
X⁻ is an inorganic, organic or preferably organometallic anion having a negative charge or is 1/x of an inorganic, organic or organometallic anion having x negative charges, x being a number from 2 to 4, or is a mixture thereof;
R₁, R₂, R₇, R₈ and R₁₅ are each independently of the others C₁-C₂₄alkyl, C₃-C₂₄cycloalkyl, C₁-C₄alkyl-[O—C₁-C₄alkylene]ₘ, C₁-C₄alkyl-[NH—C₁-C₄alkylene]ₘ, C₂-C₂₄alkenyl or C₃-C₂₄cycloalkenyl each unsubstituted or substituted by one or more optionally identical or different R₁₈ radicals; or C₆-C₁₂aryl, C₄-C₁₂heteroaryl or C₇-C₁₂aralkyl each unsubstituted or substituted by one or more optionally identical or different R₁₉ radicals; or
R₁ and R₂ together as a pair are C₁-C₂₄alkylene, C₃-C₂₄cycloalkylene, C₂-C₂₄alkenylene, C₁-C₂₄cycloalkenylene or C₇-C₁₂aralkylene each unsubstituted or substituted by one or more optionally identical or different R₁₈ radicals;
R₃, R₄, R₅, R₆, R₉, R₁₀, R₁₁, R₁₂, R₁₃, R₁₄ and R₁₆ are each independently of the others hydrogen, R₁₉, C₁-C₁₂alkyl, C₃-C₁₂cycloalkyl, C₂-C₂₄alkenyl or C₃-C₂₄cycloalkenyl each unsubstituted or substituted by one or more optionally identical or different R₁₈ radicals; or C₆-C₁₂aryl, C₄-C₁₂heteroaryl or C₇-C₁₂aralkyl each unsubstituted or substituted by one or more optionally identical or different R₁₉ radicals; or
R₃ and R₄ and/or R₅ and R₆, and R₉ and R₁₀ and/or R₁₁ and R₁₂, in each case together as a pair, are 1,4-buta-1,3-dienylene unsubstituted or substituted by one or more optionally identical or different R₁₉ radicals, with the result that together with the common phenyl a naphthyl is formed;
it being possible for two, three or more compounds of formula (I), (II), (III) or (IV) to be bonded by direct bonds or by —NH—, —NR₁₅—, —O—, —CO—, —S—, —SO—, —SO₂—, C₁-C₁₂alkylene or C₃-C₁₂cycloalkenylene bridges between their respective substituents R₁ and/or R₂, R₃ and/or R₄, or R₉ and/or R₁₀;
R₁₇ is hydrogen, C₁-C₁₂alkoxy, C₃-C₁₂cycloalkoxy, C₁-C₁₂alkylthio, C₃-C₁₂cycloalkylthio, nitro, cyano, formyl, C₁-C₁₂alkyl, C₃-C₁₂cycloalkyl, C₂-C₁₂alkenyl or C₃-C₁₂cycloalkenyl each unsubstituted or substituted by one or more optionally identical or different halogen, hydroxy, C₁-C₁₂alkoxy or C₃-C₁₂cycloalkoxy radicals; or C₆-C₁₂aryl, C₄-C₁₂heteroaryl or C₇-C₁₂aralkyl each unsubstituted or substituted by one or more optionally identical or different R₁₉ radicals;
R₁₈ is halogen, hydroxy, O—R₂₀, O—CO—R₂₀, S—R₂₀, amino, NH—R₂₀, NR₂₀R₂₁, NR₂₀—CO—R₂₂, NR₂₀COOR₂₂, cyano, formyl, CO—R₂₀, COO—R₂₀, carboxy, carbamoyl, CONH—R₂₀, CONR₂₀R₂₁, ureido, NR₂₀—CO—NHR₂₂, phosphato, PR₂₀R₂₂, POR₂₀OR₂₂, P(═O)OR₂₀OR₂₂, OPR₂₀R₂₂, OPR₂₀OR₂₂, OP(═O)R₂₀OR₂₂, OP(═O)OR₂₀OR₂₂, OPO₃R₂₀, sulfato or sulfo; or C₁-C₁₂alkoxy or C₁-C₁₂cycloalkoxy each mono- or poly-substituted by halogen;
R₁₉ is halogen, nitro, cyano, hydroxy, O—R₂₃, O—CO—R₂₃, S—R₂₃, formyl, CH═C(CN)₂, CH═C(CN)CONH₂, CH═C(CN)CONHR₂₃, CH═C(CN)CONR₂₃R₂₄, CH═C(CN)COOR₂₃, CH═C(COOR₂₃)COOR₂₄, amino, NHR₂₃, NR₂₃R₂₄, CONH₂, CONHR₂₃, CONR₂₃R₂₄, SO₂C₁-C₁₂alkyl, SO₂NH₂, SO₂NHR₂₃, SO₂NR₂₃R₂₄, COOH, COR₂₃, COOR₂₃, NHCOR₂₃, NR₂₃COR₂₅, NHCOOR₂₃, NR₂₃COOR₂₅, ureido, NR₂₃—CO—NHR₂₅, phosphato, PR₂₃R₂₅, POR₂₃OR₂₅, P(═O)OR₂₃OR₂₅, OPR₂₃R₂₅, OPR₂₃OR₂₅, OP(═O)R₂₃OR₂₅, OP(═O)OR₂₃OR₂₅, OPO₃R₂₃, sulfato or sulfo; or C₁-C₁₂alkyl, C₃-C₁₂cycloalkyl, C₁-C₁₂alkylthio, C₁-C₁₂cycloalkylthio, C₁-C₁₂alkoxy or C₃-C₁₂cycloalkoxy each unsubstituted or substituted by one or more optionally identical or different R₁₈ radicals;
R₂₀, R₂₁ and R₂₂ are each independently of the others C₁-C₁₂alkyl, C₃-C₁₂cycloalkyl, C₂-C₁₂alkenyl, C₃-C₁₂cycloalkenyl, C₆-C₁₂aryl, C₄-C₁₂heteroaryl or C₇-C₁₂aralkyl; or
R₂₀ and R₂₁, together with the common nitrogen, are pyrrolidine, piperidine, piperazine or morpholine each unsubstituted or mono- to tetra-substituted by C₁-C₄alkyl;
R₂₃, R₂₄ and R₂₅ are each independently of the others C₁-C₁₂alkyl, C₃-C₁₂cycloalkyl, C₂-C₁₂alkenyl or C₃-C₁₂cycloalkenyl each unsubstituted or substituted by one or more optionally identical or different halogen, hydroxy, C₁-C₁₂alkoxy or C₃-C₁₂cycloalkoxy radicals; or C₆-C₁₂aryl, C₄-C₁₂heteroaryl or C₇-C₁₂aralkyl each unsubstituted or substituted by one or more optionally identical or different R₂₆ radicals; or
R₂₃ and R₂₄, together with the common nitrogen, are pyrrolidine, piperidine, piperazine or morpholine each unsubstituted or mono- to tetra-substituted by C₁-C₄alkyl; or carbazole, phenoxazine or phenothiazine each unsubstituted or substituted by one or more optionally identical or different R₂₆ radicals;
R₂₆ is R₁₈ or is C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more optionally identical or different R₁₈ radicals; and
m is a number from 1 to 10.

2. An optical recording medium according to claim 1, wherein A₁ and A₂ are each S and Q is N 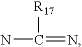
R₁, R₂, R₇, R₈ and R₁₅ are each independently of the others C₁-C₂₄alkyl, C₁-C₄alkyl-[O—C₁-C₄alkylene]ₘ or C₁-C₄alkyl-[NH—C₁-C₄alkylene]ₘ each unsubstituted or substituted by one or more optionally identical or different R₁₈ radicals; or C₆-C₁₂aryl unsubstituted or substituted by one or more optionally identical or different R₁₉ radicals; or
R₁ and R₂ together as a pair are C₁-C₂₄alkylene unsubstituted or substituted by one or more optionally identical or different R₁₈ radicals;
R₁₇ is hydrogen, cyano, C₁-C₁₂alkyl unsubstituted or substituted by one or more halogens, or phenyl unsubstituted or substituted by one or more optionally identical or different R₁₉ radicals;
R₁₈ is halogen, hydroxy, O—R₂₀, cyano, COO—R₂₀, carboxy, sulfato or sulfo; and
R₁₉ is halogen, nitro, cyano, O—R₂₃, CH═C(CN)₂, COOR₂₃, ureido, P(═O)OR₂₃OR₂₅ or sulfo.

3. An optical recording medium according to either claim 1 or claim 2, wherein the recording layer comprises a compound of formula (I) or (III), preferably a compound of formula (I).

4. An optical recording medium according to claim 1, 2 or 3, wherein the compound of formula (I), (II), (III) or (IV) contains branched C₃-C₂₄alkyl or branched C₃-C₂₄alkenyl.

5. An optical recording medium according to claim 1, 2, 3 or 4, wherein X⁻ is an organic or preferably organometallic anion.

6. An optical recording medium according to claim 1, 2, 3, 4 or 5, wherein the substrate has a thickness of from 10 μm to 1 mm with a guide groove of a depth of from 10 to 200 nm and a width of from 100 to 400 nm on the coating side.

7. An optical recording medium according to claim 6, wherein the guide groove is a spiral with a spacing of from 200 to 600 nm between 2 revolutions.

8. An optical recording medium according to claim 1, 2, 3, 4, 5, 6 or 7, wherein the guide groove has a rectangular, trapezium-shaped or V-shaped cross-sectional profile.

9. An optical recording medium according to claim 1, 2, 3, 4, 5, 6, 7 or 8, wherein the recording layer is substantially amorphous.

10. An optical recording medium according to claim 9, wherein the recording layer has a thickness of from 20 to 150 nm in the guide groove and a thickness of from 0 to 30 nm in the remainder of the surface.

11. An optical recording medium according to claim 1, 2, 3, 4, 5, 6, 7, 8, 9 or 10, wherein the reflecting layer has a thickness of from 5 to 200 nm.

12. An optical recording medium according to claim 11, wherein the reflecting layer consists of aluminium, silver, gold or an alloy thereof.

13. An optical recording medium according to claim 1, 2, 3, 4, 5, 6, 7, 8, 9, 10, 11 or 12 comprising in addition a covering layer, wherein the substrate, reflector layer, recording layer and covering layer are arranged in that sequence.

14. An optical recording medium comprising a substrate, a recording layer and a reflecting layer, wherein the recording layer comprises a polymer obtained from homo- or copolymerisation of a compound selected from the group consisting of compounds of formula (I), (II), (III) or (IV) according to claim 1 having an unsaturated, non-aromatic carbon-carbon bond.

15. A method for the recording or playback of data, which comprises recording or playing back the data at a wavelength of from 350 to 500 nm on an optical recording medium according to claim 1, 2, 3, 4, 5, 6, 7, 8, 9, 10, 11, 12, 13 or 14.

16. An optical recording medium comprising, in the following arrangement,
a) a supporting material consisting of a reflecting metal or, preferably, of a polymer having a reflecting metallic layer;
b) an optical recording layer;
c) a separating layer consisting of a metallic, crosslinked organometallic or dielectric inorganic substance; and
d) a covering layer.

17. A method for the recording or playback of data, which comprises recording or playing back the data at a wavelength of from 350 to 500 nm on an optical recording medium according to claim 16.

18. A compound of formula (I), (II), (III) or (IV) according to claim 1, which contains branched C₃-C₂₄alkyl or branched C₃-C₂₄alkenyl.

19. A compound of formula (I), (II), (III) or (IV) according to claim 1 or 19, wherein X⁻ is an organic or preferably organometallic anion.

20. A compound of formula (I), (II), (III) or (IV) according to claim 1, comprising a transition metal metallocene moiety, preferably or

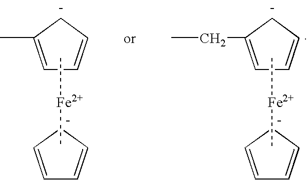

21. A compound of formula (I) or (III) according to claim 1, preferably of formula (I), with the proviso that said compound is not of the group consisting of:
compounds of formula (I) wherein Q is N, A₁ and A₂ are both S, R₁ and R₂ are unsubstituted linear C₁-C₁₈alkyl or with hydroxy or sulfo substituted linear C₁-C₃alkyl, and R₃ and R₅ are both H, halogen or OR₂₃, or a salt thereof;
compounds of formula (I) wherein Q is N or P, A₁ and A₂ are both N(R₁₅), R₁ and R₂ are each C₁-C₂alkyl or together C₁-C₃alkylene, R₃, R₄, R₅ and R₆ are all hydrogen, and R₁₅ is C₁-C₂alkyl; and
a compounds of formula (III) wherein Q is N, A₁ and A₂ are both S, R₁ and R₂ are both methyl, R₁₀ and R₁₂ are both unsubstituted phenyl, and R₉ and R₁₁ are both hydrogen.

22. A compound of formula (I) or (III) according to claim 1, selected from the group consisting of
compounds of formula (I) wherein A₁ and A₂ are both S and R₁ and R₂ are each independently of the other C₃-C₂₄cycloalkyl, C₁-C₄alkyl-[O—C₁-C₄alkylene]), C₁-C₄alkyl-[NH—C₁-C₄alkylene]ₘ, C₂-C₂₄alkenyl, C₃-C₂₄cycloalkenyl, C₁-C₁₂aralkyl or branched C₃-C₂₄alkyl;
compounds of formula (I) wherein A₁ and A₂ are both S and R₃, R₄, R₅ and/or R₆ is C₁-C₁₂alkyl;
compounds of formula (I) wherein A₁ and A₂ are both S and comprise a radical R₁₈ which is halogen, O—R₂₀, cyano, CO—R₂₀ or COO—R₂₀, or a radical R₁₉ which is S—R₂₃ or SO₂C₁-C₁₂alkyl;
compounds of formula (I) wherein A₁ and A₂ are both N(R₁₅) and R₃, R₄, R₅ or R₆ is a radical R₁₉ selected from the group consisting of halogen, O—R₂₃, O—CO—R₂₃, S—R₂₃, amino, NHR₂₃ and NR₂₃R₂₄, in which compounds R₁, R₂ and/or R₁₅ is preferably C₁-C₂₄alkyl, in particular C₁-C₂alkyl;
compounds of formula (III) wherein A₁ and A₂ are both S and R₁, R₂ or R₁ and R₂ is C₂-C₂₄alkyl, C₃-C₂₄cycloalkyl, C₁-C₄alkyl-[O—C₁-C₄alkylene]ₘ, C₂-C₂₄alkenyl or C₃-C₂₄cycloalkenyl; or R₁ and R₂ together as a pair are C₂-C₂₄alkylene; and
compounds of formula (III) wherein A₁ and A₂ are both S and R₉, R₁₀, R₁₁ and/or R₁₂ is hydrogen, R₁₉, C₁-C₁₂alkyl or C₆-C₁₂aryl unsubstituted or substituted by one or more optionally identical or different R₁₉ radicals, and R₁₉ is halogen, nitro, cyano, O—R₂₃ or SO₂C₁-C₁₂alkyl.

23. A compound according to claim 22, wherein Q is N.

24. A compound according to claim 18, 19, 20, 21, 22 or 23 of formula (I).
